(19) United States
(12) Patent Application Publication
(10) Pub. No.: US 2026/0040292 A1
(43) Pub. Date: Feb. 5, 2026

(54) METHOD FOR WIRELESS COMMUNICATION, AMBIENT POWER DEVICE, AND COMMUNICATION DEVICE

(71) Applicant: GUANGDONG OPPO MOBILE TELECOMMUNICATIONS CORP., LTD., Dongguan (CN)

(72) Inventors: Shengjiang CUI, Dongguan (CN); Weijie XU, Dongguan (CN); Jinyu ZHANG, Dongguan (CN)

(21) Appl. No.: 19/358,637

(22) Filed: Oct. 15, 2025

Related U.S. Application Data
(63) Continuation of application No. PCT/CN2023/088788, filed on Apr. 17, 2023.

(51) Int. Cl. H04W 72/0453; H04L 5/00

(52) U.S. Cl. CPC H04W 72/0453; H04L 5/0048

(57) ABSTRACT

A method for wireless communication, an ambient power (AMP) device, and a communication device are provided. The method for wireless communication includes the following. An AMP device transmits a reference signal on N candidate frequency-domain resources. The reference signal transmitted on the N candidate frequency-domain resources is used to determine a position of the AMP device or a position of a receiver of the reference signal, and/or the reference signal transmitted on the N candidate frequency-domain resources is used to determine a distance between the AMP device and the receiver of the reference signal. N is a positive integer and N>2.

### CROSS-REFERENCE TO RELATED APPLICATION(S)

This application is a continuation of International Application No. PCT/CN2023/088788, filed Apr. 17, 2023, the entire disclosure of which is hereby incorporated by reference.

### TECHNICAL FIELD

Embodiments of the disclosure relate to the field of communication, and more particularly, to a method for wireless communication, an ambient power (AMP) device, and a communication device.

### BACKGROUND

With low complexity and low cost, ambient power (AMP) devices can be made maintenance-free and battery-free, can support energy harvesting and/or backscattering communication, and can realize high-density and large-scale deployment at a relatively low cost. In view of service characteristics of the AMP device, limitations of capabilities of the AMP device, and limitations of operating power consumption of the AMP device, a conventional positioning manner cannot satisfy positioning or ranging requirements for the AMP device. For the AMP device, how to realize positioning or ranging is a problem that needs to be solved.

### SUMMARY

A method for wireless communication, an ambient power (AMP) device, and a communication device are provided in embodiments of the disclosure.

In a first aspect, a method for wireless communication is provided. The method includes the following. An AMP device transmits a reference signal on N candidate frequency-domain resources. The reference signal transmitted on the N candidate frequency-domain resources is used to determine a position of the AMP device or a position of a receiver of the reference signal, and/or the reference signal transmitted on the N candidate frequency-domain resources is used to determine a distance between the AMP device and the receiver of the reference signal. N is a positive integer and N≥2.

In a second aspect, an AMP device is provided. The AMP device includes a transceiver, a processor coupled to the transceiver; and a memory storing a computer program which, when executed by the processor, causes the AMP device to transmit a reference signal on N candidate frequency-domain resources. The reference signal transmitted on the N candidate frequency-domain resources is used to determine a position of the AMP device or a position of a receiver of the reference signal, and/or the reference signal transmitted on the N candidate frequency-domain resources is used to determine a distance between the AMP device and the receiver of the reference signal. N is a positive integer and N≥2.

In a third aspect, a communication device is provided. The communication device includes a transceiver, a processor coupled to the transceiver; and a memory storing a computer program which, when executed by the processor, causes the communication device to receive a reference signal transmitted by an AMP device on N candidate frequency-domain resources. The reference signal transmitted on the N candidate frequency-domain resources is used to determine a position of the AMP device or a position of the communication device, and/or the reference signal transmitted on the N candidate frequency-domain resources is used to determine a distance between the AMP device and the communication device. N is a positive integer and N≥2.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiment described herein.

### BRIEF DESCRIPTION OF THE DRAWINGS

The disclosure is best understood from the following detailed description when read in conjunction with the accompanying drawings.

FIG. 1 is a schematic diagram of a communication system architecture to which embodiments of the disclosure are applicable.

FIG. 2 is a schematic diagram of zero-power communication provided in the disclosure.

FIG. 3 is a schematic diagram of energy harvesting provided in the disclosure.

FIG. 4 is a schematic diagram of backscattering communication provided in the disclosure.

FIG. 5 is a circuit diagram of resistive load modulation provided in the disclosure.

FIG. 6 is a schematic diagram of a channel bandwidth provided in the disclosure.

FIG. 7 is a schematic flow chart of a method for wireless communication provided in embodiments of the disclosure.

FIGS. 8 to 13 are schematic diagrams illustrating candidate frequency-domain resources for frequency-hopping transmissions of a reference signal by an ambient power (AMP) device provided in embodiments of the disclosure.

FIG. 14 is a schematic diagram illustrating a relative number of an available candidate frequency-domain resource provided in embodiments of the disclosure.

FIG. 15 is a schematic diagram illustrating time of arrival (TOA) estimation in intra-channel frequency-hopping provided in embodiments of the disclosure.

FIG. 16 is a schematic diagram illustrating TOA estimation in inter-channel frequency-hopping provided in embodiments of the disclosure.

FIG. 17 is a schematic block diagram of an AMP device provided in embodiments of the disclosure.

FIG. 18 is a schematic block diagram of a communication device provided in embodiments of the disclosure.

FIG. 19 is a schematic block diagram of another communication device provided in embodiments of the disclosure.

FIG. 20 is a schematic block diagram of an apparatus provided in embodiments of the disclosure.

FIG. 21 is a schematic block diagram of a communication system provided in embodiments of the disclosure.

### DETAILED DESCRIPTION

The following will describe technical solutions of embodiments of the disclosure with reference to the accompanying drawings in embodiments of the disclosure. Apparently, the embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area network (WLAN), a wireless fidelity (Wi-Fi), a 5th-generation (5G) communication system, a 6th-generation (6G) communication system, or other communication systems, etc.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, sidelink (SL) communication, vehicle to everything (V2X) communication, etc. Embodiments of the disclosure can also be applied to these communication systems.

In some embodiments, the communication system in embodiments of the disclosure may be applied to a carrier aggregation (CA) scenario, or may be applied to a dual connectivity (DC) scenario, or may be applied to a standalone (SA) network deployment scenario, or may be applied to a non-standalone (NSA) network deployment scenario.

In some embodiments, the communication system in embodiments of the disclosure is applicable to an unlicensed spectrum, and an unlicensed spectrum may be regarded as a shared spectrum. Alternatively, the communication system in embodiments of the disclosure is applicable to a licensed spectrum, and a licensed spectrum may be regarded as a non-shared spectrum.

In some embodiments, the communication system in embodiments of the disclosure may be applicable to frequency range 1 (FR1) (corresponding to a frequency range of 410 Megahertz (MHz) to 7.125 Gigahertz (GHz), FR2 (corresponding to a frequency range of 24.25 GHz to 52.6 GHz), as well as new frequency ranges, such as high-frequency bands corresponding to a frequency range of 52.6 GHz to 71 GHz or a frequency range of 71 GHz to 114.25 GHz.

Various embodiments of the disclosure are described in connection with an ambient power (AMP) device and a communication device. The AMP device may also be referred to as a zero-power device or an ambient Internet of things (IoT) device. The communication device may be a network device (such as a base station), or an access point (AP), or a terminal device, or a station (STA), or a transmission reception point (TRP), or a relay device. Certainly, the communication device may also be another type of device, and the embodiments of the disclosure are not limited in this regard.

The terminal device may be a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

In embodiments of the disclosure, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In embodiments of the disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, a vehicle-mounted communication device, a wireless communication chip/application specific integrated circuit (ASIC)/system on chip (SoC).

By way of explanation rather than limitation, in embodiments of the disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, and the network device may be an AP in a WLAN, a base transceiver station (BTS) in GSM or CDMA, or may be a Node B (NB) in WCDMA, or may be an evolutional Node B (eNB or eNodeB) in LTE, or a relay station or AP, or an in-vehicle device, a wearable device, a network device or a base station (gNB) or a TRP in an NR network, a network device in a future evolved PLMN, or a network device in an NTN, etc.

By way of explanation rather than limitation, in embodiments of the disclosure, the network device may be mobile. For example, the network device may be a mobile device. In some embodiments, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, the network device may also be a base station deployed on land or water.

In embodiments of the disclosure, the network device can serve a cell, and the terminal device can communicate with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

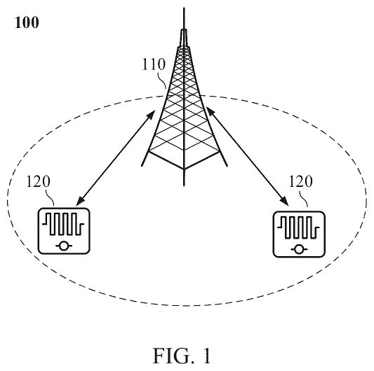

Exemplarily, FIG. 1 illustrates a communication system 100 to which embodiments of the disclosure are applicable. The communication system 100 may include a communication device 110. The communication device 110 may be a device for communicating with an AMP device 120 (also referred to as “zero-power device”). The communication device 110 can provide a communication coverage for a specific geographical area and communicate with AMP devices in the coverage area.

FIG. 1 exemplarily illustrates one communication device and two AMP devices. Optionally, the communication system 100 may also include multiple communication devices, and there may be other quantities of AMP devices in a coverage area of each of the communication devices. Embodiments of the disclosure are not limited in this regard.

In some embodiments, the communication system 100 may further include other network entities such as a network controller, a mobility management entity (MME), or the like, and embodiments of the disclosure are not limited in this regard.

It may be understood that, in embodiments of the disclosure, a device with communication functions in a network/system may be referred to as a “communication device”. Taking the communication system 100 illustrated in FIG. 1 as an example, the communication device may include the communication device 110 and the AMP device(s) 120 that have communication functions. The communication device 110 and the AMP device(s) 120 may be the devices described above and will not be repeated herein. The communication device may further include other devices such as a network controller, an MME, or other network entities in the communication system 100, and embodiments of the disclosure are not limited in this regard.

It may be understood that, the terms “system” and “network” herein are usually used interchangeably throughout this disclosure. The term “and/or” herein only describes an association relationship between associated objects, which means that there may be three relationships. For example, A and/or B may mean A alone, both A and B exist, and B alone. In addition, the character “/” herein generally indicates that the associated objects are in an “or” relationship.

Terms used in the embodiments of the disclosure are merely intended for explaining embodiments of the disclosure rather than limiting the disclosure. The terms “first”, “second”, “third”, “fourth”, and the like used in the specification, the claims, and the accompany drawings of the disclosure are used to distinguish different objects rather than describe a particular order. In addition, the terms “include”, “comprise”, and “have” as well as variations thereof are intended to cover non-exclusive inclusion.

It may be understood that, “indication” referred to in embodiments of the disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that that there is an association relationship between A and B.

In the elaboration of embodiments of the disclosure, the term “correspondence” may mean that there is a direct or indirect correspondence between the two, may mean that there is an association relationship between the two, or may mean a relationship of indicating and being indicated or configuring and being configured, etc.

In embodiments of the disclosure, the “predefined” or “preconfigured” may be implemented by pre-saving a corresponding code or table in a device (for example, including the terminal device and the network device) or in other manners that can be used for indicating related information, and the disclosure is not limited in this regard. For example, the “pre-defined” may mean defined in a protocol.

In embodiments of the disclosure, the “protocol” may refer to a communication standard protocol, which may include, for example, an LTE protocol, an NR protocol, a Wi-Fi protocol, or an evolution of a protocol related to other communication systems, and the protocol type is not limited in the disclosure.

To facilitate better understanding of the embodiments of the disclosure, the zero-power communication technology involved in the disclosure will be described.

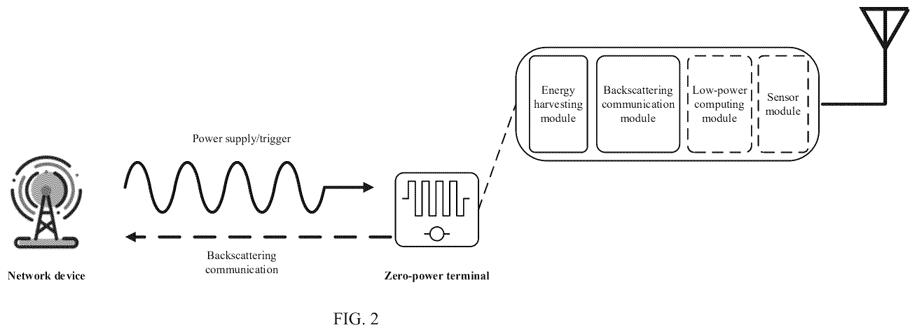

Zero-power communication adopts energy (power) harvesting and/or backscattering communication technologies. A zero-power communication network is composed of a network device and a zero-power device(s), as illustrated in FIG. 2. The network device is configured to transmit wireless power supply signals and downlink communication signals to the zero-power device, and to receive backscattering signals from the zero-power device. A basic zero-power device includes an energy harvesting module, a backscattering communication module, and a low-power computing module. In addition, the zero-power device may further include a memory or a sensor for storing basic information (e.g., item identification, etc.) or acquiring sensor data such as ambient temperature and ambient humidity.

Key technologies of zero-power communication primarily include radio frequency (RF) energy harvesting and backscattering communication.

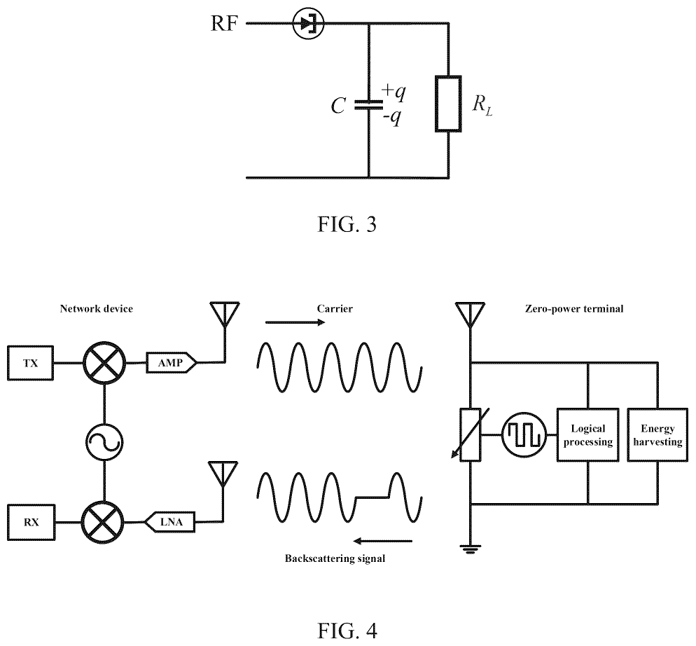

Specifically, RF energy harvesting may be implemented as illustrated in FIG. 3. An RF energy harvesting module is configured to collect energy from electromagnetic waves in space based on the principle of electromagnetic induction, thereby obtaining the energy required to power the zero-power device, such as for driving a low-power demodulation and modulation module(s), a sensor(s), memory access, and the like. As such, the zero-power device does not require a traditional battery.

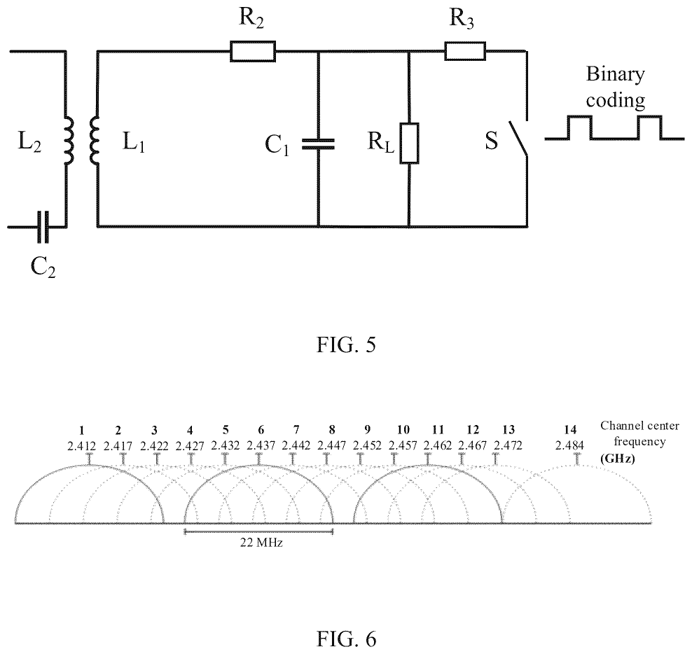

Specifically, backscattering communication may be implemented as illustrated in FIG. 4. A zero-power communication terminal receives a wireless signal transmitted by a network and modulates the wireless signal to load information to be transmitted, and then radiates the modulated signal via an antenna(s). This information transmission process is referred to as backscattering communication. Backscattering is closely related to load modulation. Load modulation means adjustment and control of circuit parameters of an oscillating loop in the zero-power device based on a beat of a data stream, thereby changing parameters such as an impedance of an electronic tag to achieve modulation. Load modulation mainly include resistive load modulation and capacitive load modulation. In resistive load modulation, a resistor is connected in parallel with a load and is switched on or off under the control of a binary data stream, as illustrated in FIG. 5. The on/off switching of the resistor may cause a voltage change in the circuit, thereby achieving amplitude shift keying (ASK) modulation, i.e., achieving signal modulation and transmission by adjusting the amplitude of the backscattering signal of the zero-power device. Similarly, in capacitive load modulation, the resonant frequency of the circuit can be changed by switching a capacitor on or off, thereby achieving frequency shift keying (FSK) modulation, i.e., achieving signal modulation and transmission by adjusting the operating frequency of the backscattering signal of the zero-power device.

As can be seen, the zero-power device performs information modulation on an incident signal via load modulation to achieve backscattering communication. As a result, the zero-power device offers the following significant advantages:
(1) The zero-power device does not actively transmit signals, and thus does not require a complex RF chain, such as a power amplifier (PA), a RF filter, etc.;
(2) The zero-power device does not need to actively generate high-frequency signals, and thus does not require a high-frequency crystal oscillator;
(3) With the help of backscattering communication, the zero-power device does not consume its own power for signal transmission.

Owing to its advantages such as ultra-low cost, zero-power consumption, and small size, zero-power communication can be widely applied across various industries, such as logistics, intelligent warehousing, smart agriculture, energy and power, and industrial Internet in vertical sectors; and in personal applications such as smart wearables and smart homes.

To facilitate better understanding of the embodiments of the disclosure, a power supply signal and a trigger signal in a zero-power communication system involved in the disclosure will be described.

Power supply signal: A carrier of the power supply signal may be a base station, a smart phone, a smart gateway, a charging station, a micro base station, or the like. In terms of a frequency band, a radio wave for power supply may be low-frequency, medium-frequency, high-frequency, or the like. In terms of a waveform, a radio wave for power supply may be a sine wave, a square wave, a triangular wave, a pulse, a rectangular wave, or the like. In addition, the power supply signal may be a continuous wave or a discontinuous wave (i.e., an interruption is allowed for a certain time). The power supply signal may be a certain signal specified in the 3rd generation partnership project (3GPP) standard, for example, a sounding reference signal (SRS), a physical uplink shared channel (PUSCH), a physical random access channel (PRACH), a physical uplink control channel (PUCCH), a physical downlink control channel (PDCCH), a physical downlink shared channel (PDSCH), a physical broadcast channel (PBCH), or the like.

Trigger signal/control information: A carrier of the trigger signal may be a base station, a smart phone, a smart gateway, or the like. In terms of a frequency band, a radio wave for power supply may be low-frequency, medium-frequency, high-frequency, or the like. In terms of a waveform, a radio wave for power supply may be a sine wave, a square wave, a triangular wave, a pulse, a rectangular wave, or the like. In addition, the trigger signal may be a continuous wave or a discontinuous wave (i.e., an interruption is allowed for a certain time). The trigger signal may be a certain signal specified in the 3GPP standard, for example, an SRS, a PUSCH, a PRACH, a PUCCH, a PDCCH, a PDSCH, a PBCH, or the like; or may be a new signal.

To facilitate better understanding of the embodiments of the disclosure, the classification of zero-power devices involved in the disclosure will be described.

Optionally, based on the energy source and usage mode of zero-power devices, zero-power devices may be classified into passive zero-power devices, semi-passive zero-power devices, and active zero-power devices.

### 1) Passive Zero-Power Device

A zero-power device does not require an internal battery. When the zero-power device is close to a network device (such as a reader of a radio frequency identification (RFID) system), the zero-power device is within the near-field range formed by the radiation of an antenna(s) of the network device. Therefore, an antenna(s) of the zero-power device generates an induced current through electromagnetic induction, and the induced current drives a low-power chip circuit of the zero-power device. This enables the demodulation of a signal on a forward link (downlink, a link from the network device to the zero-power device) and the modulation of a signal on a backward link (uplink, a link from the zero-power device to the network device). For a backscattering link, the zero-power device performs signal transmission using backscattering.

As can be seen, the passive zero-power device does not require a built-in battery to drive either the forward link or a reverse link (i.e., the backward link), and is thus a truly zero-power device.

The passive zero-power device do not require a battery, and an RF circuit and a baseband circuit therein are very simple, for example, components such as a low-noise amplifier (LNA), a PA, a crystal oscillator, an analog-to-digital conversion (ADC) are not required. Therefore, the passive zero-power device has many advantages, such as small size, light weight, very low cost, and long service life.

A passive zero-power terminal can also support other manners of energy harvesting, and obtain energy for circuit driving by harvesting/collecting energy (such as optical energy, thermal energy, kinetic energy, mechanical energy, etc.) from the environment, to support communication of a terminal device.

### 2) Semi-Passive Zero-Power Device

A semi-passive zero-power device is also not equipped with a conventional battery, but it can use an RF energy harvesting module to collect energy from radio waves, or use an energy harvesting module to collect energy from the environment (such as solar energy, thermal energy, mechanical vibration energy, etc.), and store the collected energy in an energy storage unit (such as a capacitor). After the energy storage unit obtains energy, the low-power chip circuit of the zero-power device can be driven. This enables the demodulation of a signal on the forward link and the modulation of a signal on the backward link. For the backscattering link, the zero-power device performs signal transmission using backscattering.

As can be seen, the semi-passive zero-power device does not require a built-in battery to drive either the forward link or the reverse link. Although energy stored in the capacitor is used during operation, the energy originates from the radio energy collected by the energy harvesting module, and therefore, the semi-passive zero-power device is also a truly zero-power device.

The semi-passive zero-power device inherits many advantages of the passive zero-power device, and thus has many advantages such as small size, light weight, very low cost, and long service life.

### 3) Active Zero-Power Device

In some scenarios, the zero-power device used may also be an active zero-power device. This type of terminal may be equipped with a built-in battery (a conventional battery such as a dry battery, or a rechargeable lithium battery, etc.). The battery is used to drive the low-power chip circuit of the zero-power device. This enables the demodulation of a signal on the forward link and the modulation of a signal of the backward link. However, for the backscattering link, the zero-power device performs signal transmission using backscattering. Therefore, the zero-power feature of such terminals is mainly reflected in that signal transmission on the reverse link does not consume power from the terminal itself but uses backscattering. Although the active zero-power device uses a battery, due to the adoption of ultra-low-power communication technology, power consumption of the active zero-power device is very low. Therefore, compared with existing technologies, the battery life can be significantly improved.

The active zero-power device uses a built-in battery to supply power to an RFID chip, thereby increasing the read/write range of a tag and improving the reliability of communication. Therefore, the active zero-power device can be applied in scenarios with relatively high requirements for communication range, read latency, and so on.

Some zero-power terminals, such as a semi-passive zero-power terminal or an active zero-power terminal, may have a capability of active transmission. In other words, in addition to backscattering, active transmission can also be used for communication on the backward link.

It is well known that, similar to service types of other IoT, service types of the zero-power IoT are also mainly uplink services. Therefore, based on the type of transmitter, zero-power devices may be classified into: zero-power devices based on backscattering; zero-power devices based on an active transmitter; and zero-power devices supporting both backscattering and an active transmitter.

### 1) Zero-Power Device Based on Backscattering

This type of zero-power device transmits uplink data using the backscattering manner as described above. This type of device does not have an active transmitter with active transmission capability, but has only a transmitter with backscattering. Therefore, when this type of terminal performs data transmission, the network device is required to provide a carrier, and this type of terminal performs data transmission using backscattering based on the carrier.

### 2) Zero-power device based on an active transmitter

This type of zero-power device performs uplink data transmission using an active transmitter with active transmission capability. Therefore, when transmitting data, this type of zero-power device can transmit data using its own active transmitter without requiring the network device to provide a carrier. The active transmitter applicable to the zero-power device may be, for example, an ultra-low-power ASK or ultra-low-power FSK transmitter. Based on current implementations, under the condition of transmitting a signal of 100 microwatts (μW) using this type of transmitter, the overall power consumption can be reduced to 400 μW-600 μW.

### 3) Zero-Power Device Supporting Both Backscattering and an Active Transmitter

This type of terminal supports both backscattering and an active transmitter. The terminal may determine, according to different conditions (such as power status or available ambient energy) or based on the scheduling of the network device, which uplink signal transmission manner is to be used, i.e., whether to use backscattering or whether to perform active transmission using the active transmitter.

To facilitate better understanding of the embodiments of the disclosure, the cellular passive IoT involved in the disclosure will be described.

The cellular IoT is thriving. For example, in 3GPP, IoT technologies such as narrowband IoT (NB-IoT), MTC, and reduced capability (RedCap) have been standardized. However, there are still many IoT communication requirements under certain scenarios that cannot be satisfied by existing technologies.

An example is harsh communication environments. Some IoT scenarios may face extreme environments such as high temperature, extremely low temperature, high humidity, high pressure, high radiation, or high-speed movement. Examples include ultra-high-voltage substations, high-speed train track monitoring, environmental monitoring in frigid zones, industrial production lines, etc. In these scenarios, due to limitations of the operating environment of conventional power supplies, existing IoT terminals cannot operate. Moreover, extreme environments are also unfavorable for IoT maintenance, such as battery replacement.

Another example is the demand for ultra-small terminal forms. Some IoT communication scenarios, such as food traceability, goods circulation, and smart wearables, require terminals to be extremely small in size for convenient use in such scenarios. For example, IoT terminals used for goods management in circulation are often implemented as electronic tags, which are embedded in product packaging in a very compact form. Another example is lightweight wearable devices, which can improve the user experience while meeting user needs.

Another example is the demand for ultra-low-cost IoT communication. Many IoT communication scenarios require that the cost of IoT terminals is sufficiently low to improve competitiveness compared with other alternative technologies. For example, in logistics or warehousing scenarios, to facilitate the management of a large number of circulating items, IoT terminals can be attached to each item, and communication between the terminal and the logistics network can achieve precise management throughout the entire logistics process and life cycle. These scenarios require IoT terminal prices to be sufficiently competitive.

Therefore, to cover these unmet IoT communication needs, the cellular network also needs to develop ultra-low-cost, ultra-small, battery-free/maintenance-free IoT, and zero-power IoT can precisely meet this demand.

It may be further noted that, zero-power IoT may also be referred to as ambient power enabled IoT, abbreviated as ambient IoT. Specifically, ambient IoT devices refer to IoT devices that use various types of ambient energy, such as RF energy, optical energy, solar energy, thermal energy, mechanical energy, etc. The ambient IoT device may not have energy storage capability or may have very limited energy storage capability (e.g., using a capacitor with a capacitance of tens of microfarads (μF)).

In some embodiments, the ambient IoT device may be used in at least the following four types of scenarios:
object identification, such as logistics management, management of products in production lines, and supply chain management;
environmental monitoring, such as monitoring of temperature, humidity, and harmful gas in operating or natural environments;
positioning, such as indoor positioning, smart item locating, and production line item positioning;
intelligent control, such as intelligent control of various appliances in smart homes (turning on/off air conditioners, adjusting temperature), and intelligent control of various facilities in agricultural greenhouses (automatic irrigation, fertilization).

To facilitate better understanding of the embodiments of the disclosure, a channel in Wi-Fi involved in the disclosure will be described.

Wi-Fi is a WLAN based on the institute of electrical and electronics engineers (IEEE) 802.11 standard. There are many standard protocols for WLAN, such as the IEEE 802.11 protocol family, the HiperLAN protocol family, etc.

A list of WLAN channels contains wireless channels that may be used by IEEE 802.11 (also referred to as Wi-Fi) wireless networks.

The 802.11 working group has defined two independent frequency bands: 2.4 GHz and 4.9/5.8 GHz. Each frequency band is further divided into several channels, and each country/region has set its own policies on how to use these frequency bands, as illustrated in Table 1.

TABLE 1

| Country/region | 2.4 GHz | 5 GHz (4.9/5.8) |
|---|---|---|
| China | 2.412-2.472 GHz: | 5.725-5.825 GHz: |
| | 13 channels | 4 channels |
| Americas (federal | 2.412-2.462 GHz: | 5.15-5.35 GHz, |
| communications | 11 channels | 5.725-5.825 GHz; |
| commission (FCC)) | | 12 channels |
| North America | 2.412-2.462 GHz: | 5.15-5.35 GHz, |
| (except FCC) | 11 channels | 5.725-5.825 GHz: |
| | | 12 channels |
| Europe (European | 2.412-2.472 GHz: | 5.15-5.35 GHz: |
| telecommunications | 13 channels | 8 channels |
| standards institute | | 5470-5725 MHz: |
| (ETSI)) | | 11 channels |
| Israel | 2.432-2.472 GHz: | 5.15-5.35 GHz: |
| | 9 channels | 8 channels |
| Japan | 2.412-2.472 GHz: | 2.412-2.484 GHz: |
| | 13 channels | 14 channels |
| | (orthogonal | (complementary code |
| | frequency | keying (CCK)) |
| | division | 5.15-5.25 GHz: |
| | multiplexing (OFDM)) | 4 channels |
| Japan 2 | 2.412-2.472 GHz: | CCK5.15-5.35 GHz: |
| | 13 channels | 8 channels |
| | OFDM2.412-2.484 GHz: | |
| | 14 channels | |
| Republic of | 2.412-2.472 GHz: | 5.15-5.35 GHz, |
| Korea | 13 channels | 5.46-5.72 GHz, |
| | | 5.725-5.825 GHz: |
| | | 19 channels |
| Singapore | 2.412-2.472 GHz: | 5.15-5.35 GHz, |
| | 13 channels | 5.725-5.825 GHz: |
| | | 12 channels |
| Taiwan, China | 2.412-2.462 GHz: | 5.25-5.35 GHz, |
| | 11 channels | 5.725-5.825 GHz: |
| | | 7 channels |

A channel has an effective bandwidth of 20 MHz and an actual bandwidth of 22 MHz, where 2 MHz is a guard band, as illustrated in FIG. 6.

Center frequencies of adjacent channels are spaced 5 MHz apart from each other, and multiple adjacent channels have overlapping frequencies. There are three groups of channels that do not interfere with each other (1, 6, 11, or 2, 7, 12, or 3, 8, 13), as illustrated in Table 2.

TABLE 2

| | Bandwidth | Center frequency |
|---|---|---|
| Channel | (MHz) | (MHz) |
| 1 | 20 | 2412 |
| | | (2401-2423) |
| 2 | 20 | 2417 |
| 3 | 20 | 2422 |
| 4 | 20 | 2427 |
| 5 | 20 | 2432 |
| 6 | 20 | 2437 |
| 7 | 20 | 2442 |
| 8 | 20 | 2447 |
| 9 | 20 | 2453 |
| 10 | 20 | 2457 |
| 11 | 20 | 2463 |
| 12 | 20 | 2467 |
| 13 | 20 | 2472 |
| 14 (generally | 20 | 2484 |
| not used) | | |

To facilitate better understanding of the embodiments of the disclosure, the problem to be solved in the disclosure will be described.

With low complexity and low cost, AMP devices (also referred to as zero-power devices or ambient IoT devices) can be made maintenance-free and battery-free. The AMP devices may be classified into passive zero-power terminals, semi-passive zero-power terminals, active zero-power terminals, and the like, and obtain energy for communication by harvesting energy (such as RF energy, optical energy, thermal energy, mechanical energy, kinetic energy, etc.) from the environment. In terms of communication manners, communication manners of backscattering and/or active transmission can be supported.

Positioning is an important application scenario for the AMP device. Due to limitations of power consumption and cost of the AMP device, it is almost impossible to use a large-bandwidth positioning reference signal in a cellular positioning system to measure a reference signal time difference (RSTD) or a reception (Rx) transmission (Tx) (Rx-Tx) time difference for positioning.

A feasible manner is to use a method for a dual-frequency phase difference to determine a propagation delay/distance, thereby completing positioning/ranging. However, how to design a frequency-domain resource for a dual-frequency signal is an urgent problem to be solved.

Based on the above problems, a method for assigning frequency-domain resources for signals of different frequencies is proposed in the disclosure, which can be used by an AMP device to determine a frequency-domain resource(s) to be used in the case of transmitting signals of different frequencies, thereby realizing positioning based on a dual-frequency phase difference in a zero-power communication scenario.

To facilitate understanding of technical solutions of the embodiments of the disclosure, the technical solutions of the disclosure will be described in detail below through specific embodiments. The related art below, as an optional scheme, can be arbitrarily combined with the technical solutions of embodiments of the disclosure, which shall all belong to the protection scope of embodiments of the disclosure. Embodiments of the disclosure include at least part of the following contents.

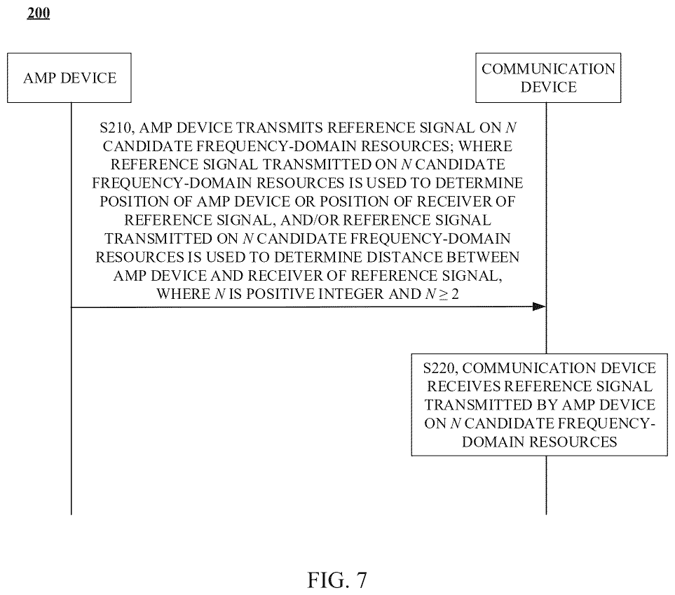

FIG. 7 is a schematic flow chart of a method 200 for wireless communication according to embodiments of the disclosure. As illustrated in FIG. 7, the method 200 for wireless communication may include at least part of the following contents.

At S210, an AMP device transmits a reference signal on N candidate frequency-domain resources. The reference signal transmitted on the N candidate frequency-domain resources is used to determine a position of the AMP device or a position of a receiver of the reference signal, and/or the reference signal transmitted on the N candidate frequency-domain resources is used to determine a distance between the AMP device and the receiver of the reference signal. N is a positive integer and N≥2.

At S220, a communication device receives the reference signal transmitted by the AMP device on the N candidate frequency-domain resources.

It may be understood that, FIG. 7 illustrates acts or operations of the method 200 for wireless communication, but these acts or operations are only examples, and in embodiments of the disclosure, other operations or variations of the operations illustrated in FIG. 7 may also be performed.

In embodiments of the disclosure, the AMP device may also be referred to as a zero-power device or an ambient IoT (A-IoT) device, which has a simple structure, low complexity, and low cost. The AMP device can support energy harvesting from ambient energy (such as optical energy, thermal energy, RF energy, mechanical energy, kinetic energy, etc.) to obtain energy required for communication, and can support communication manners of backscattering and/or active transmission.

In embodiments of the disclosure, the AMP device can be applied to Wi-Fi and/or a cellular network.

In embodiments of the disclosure, the communication device can determine the position of the AMP device based on the reference signal transmitted on the N candidate frequency-domain resources, or the communication device can determine the position of the receiver (i.e., the communication device) of the reference signal based on the reference signal transmitted on the N candidate frequency-domain resources; and/or, the communication device can determine the distance between the AMP device and the receiver (i.e., the communication device) of the reference signal based on the reference signal transmitted on the N candidate frequency-domain resources.

Specifically, for example, the communication device can determine the position of the AMP device based on a phase characteristic of the reference signal transmitted on the N candidate frequency-domain resources, where the phase characteristic may be a phase variation/phase difference, or the phase characteristic may be a phase difference between multiple frequencies (typically, positioning based on a dual-frequency phase difference).

Specifically, for example, the communication device can determine the position of the receiver (i.e., the communication device) of the reference signal based on a phase characteristic of the reference signal transmitted on the N candidate frequency-domain resources, where the phase characteristic may be a phase variation/phase difference, or the phase characteristic may be a phase difference between multiple frequencies (typically, positioning based on a dual-frequency phase difference).

Specifically, for example, the communication device can determine the distance between the AMP device and the receiver (i.e., the communication device) of the reference signal based on a phase characteristic of the reference signal transmitted on the N candidate frequency-domain resources, where the phase characteristic may be a phase variation/phase difference, or the phase characteristic may be a phase difference between multiple frequencies (typically, ranging based on a dual-frequency phase difference).

In some embodiments, the communication device may be a network device (such as a base station), or an AP, or a terminal device, or an STA, or a TRP, or a relay device. Certainly, the communication device may also be another type of device, and the embodiments of the disclosure are not limited in this regard.

In some embodiments, the “reference signal” described in embodiments of the disclosure may be a positioning reference signal (PRS) or a phase positioning reference signal.

In some embodiments, the candidate frequency-domain resource is one of: a channel, a system bandwidth, a carrier bandwidth, a bandwidth part (BWP), an aggregation/grouping/bundling of multiple BWPs, an aggregation/grouping/bundling of multiple subcarriers (also referred to as tones), and an aggregation/grouping/bundling of multiple physical resource blocks (PRBs).

Specifically, an operating band for deployment of AMP devices may be generally divided into multiple channels or carriers, and different channels may overlap or may not overlap. The AMP device can transmit a reference signal on multiple candidate frequency-domain resources in the operating band. The receiver (i.e., the communication device) can determine a propagation delay/distance between the AMP device and the receiver (i.e., the communication device) by measuring a phase and/or a phase difference of the reference signal, so as to obtain distance/position information of the AMP device. In addition, the candidate frequency-domain resource may be a channel, a BWP, an aggregation of multiple BWPs, an aggregation of multiple tones, or an aggregation of multiple PRBs.

For example, in the case where each channel has a bandwidth of 250 kilohertz (kHz) during communication using an RFID band of 920-925 MHz, a system bandwidth of 5 MHz (920-925 MHz) may be divided into 20 channels each with a bandwidth of 250 kHz. In this case, the candidate frequency-domain resource may be a channel. That is, each channel is used as one candidate frequency-domain resource, and the AMP device may transmit the reference signal on different channels.

In some embodiments, for S210, the AMP device transmits the reference signal on the N candidate frequency-domain resources in a manner of active transmission or backscattering.

In some embodiments, the N candidate frequency-domain resources are part or all of candidate frequency-domain resources in a deployment band corresponding to the AMP device. That is, in this embodiment, a candidate frequency-domain resource(s) for transmitting the reference signal can be flexibly selected.

In some embodiments, in the case where the AMP device transmits the reference signal on/over the N candidate frequency-domain resources, the AMP device transmits the reference signal over all or part of resources in each candidate frequency-domain resource among the N candidate frequency-domain resources.

For example, in the case where the AMP device transmits the reference signal over/using the N candidate frequency-domain resources, the AMP device transmits the reference signal using part of subcarriers in each candidate frequency-domain resource.

For another example, assuming that the candidate frequency-domain resource is a channel, and one channel consists of 64 subcarriers, in the case where the AMP device uses this channel, the AMP device only uses 16 middle subcarriers to transmit the reference signal.

In some embodiments, in the case where the AMP device transmits the reference signal using the N candidate frequency-domain resources, the AMP device transmits the reference signal using part of resources in each candidate frequency-domain resource among the N candidate frequency-domain resources. The part of resources in each candidate frequency-domain resource to be used may be configured (semi-statically configured or dynamically configured) by a network device, or may be predefined by a protocol, or may be determined based on a preset relationship and at least one of an identifier (ID) of the AMP device or an ID of the receiver.

In some embodiments, the N candidate frequency-domain resources do not overlap, or part of the N candidate frequency-domain resources overlap. In other words, candidate frequency-domain resources for the AMP device may not overlap with each other, or part of the candidate frequency-domain resources for the AMP device overlap.

In embodiments of the disclosure, a number of the candidate frequency-domain resource may also be referred to as an index of the candidate frequency-domain resource.

In some embodiments, the reference signal transmitted by the AMP device contains a frame header or a packet header, or the AMP device transmits information carrying the frame header or the packet header before transmitting the reference signal. The frame header or the packet header carries at least information of a time length (such as a transmission opportunity (TXOP)) in which a candidate frequency-domain resource is occupied.

Specifically, for the case where the reference signal transmitted by the AMP device contains the frame header or the packet header, the frame header or the packet header is treated as part of the reference signal. For the case where the AMP device transmits the information carrying the frame header or the packet header before transmitting the reference signal, the frame header or the packet header and the reference signal are treated as two separate parts. Before transmitting the reference signal, the AMP device needs to transmit the frame header or the packet header, so that the frame header or the packet header can share a structure with a header of another signal/channel.

It may be noted that in Wi-Fi communication, transmission of a single frame is ensured by physical carrier sensing (non-TXOP). A TXOP introduced in 802.11e actually means “contending once, obtaining a duration based transmission”. In other words, after a node succeeds in contention, the node obtains a duration for using a channel, and in this duration, the node can transmit multiple data frames. This transmission mode is also often described by the term “burst”. Transmission time of the TXOP is ensured by virtual carrier sensing.

In some embodiments, the frame header or the packet header further carries at least one of: information for identifying the AMP device, such as an ID of the AMP device;

information for identifying the receiver, such as an ID of the receiver (i.e., the communication device); a synchronization/pilot sequence for obtaining synchronization information by the receiver (i.e., the communication device); or configuration information of the reference signal transmitted by the AMP device, such as a time-domain starting position and a duration of an actual transmission, a subcarrier actually occupied, a modulation symbol on each subcarrier/a sequence, etc.

In some embodiments, the number (quantity) W of transmissions of the reference signal by the AMP device (i.e., the total number of transmissions of the reference signal on the N candidate frequency-domain resources), a duration T₁ for a single transmission of the reference signal by the AMP device, and time T during which the AMP device is scheduled by a network for communication have the following association relationship: W*T₁≤T. W is a positive integer, and both T and T₁ are positive numbers. Optionally, any two of three parameters W, T₁, and T may be configured, and then a value of the remaining one parameter is determined according to the relationship among the three parameters.

In some embodiments, the number of transmissions of the reference signal by the AMP device (also referred to as the number of frequency hops, i.e., transmission of the reference signal on different candidate frequency-domain resources is equivalent to frequency-hopping transmission of the reference signal) is predefined by a protocol. Alternatively, the number of transmissions of the reference signal by the AMP device is configured (which may be semi-statically configured or dynamically configured) by a network.

In some embodiments, a duration for a single transmission of the reference signal by the AMP device is predefined by a protocol. Alternatively, the duration fora single transmission of the reference signal by the AMP device is configured (which may be semi-statically configured or dynamically configured) by a network.

In some embodiments, a time interval between each two adjacent frequency-hopping transmissions of the reference signal by the AMP device is predefined by a protocol.

Alternatively, the time interval between each two adjacent frequency-hopping transmissions of the reference signal by the AMP device is configured (which may be semi-statically configured or dynamically configured) by a network.

In some embodiments, a maximum duration for transmission of the reference signal by the AMP device is predefined by a protocol. Alternatively, the maximum duration for transmission of the reference signal by the AMP device is configured (which may be semi-statically configured or dynamically configured) by a network.

In some embodiments, different AMP devices use the same manner to determine candidate frequency-domain resources for transmitting reference signals for ranging and/or positioning based on a dual-frequency phase difference. In other words, different terminals may use the same association relationship to determine, based on a candidate frequency-domain resource(s) used in the i-th available time unit, a candidate frequency-domain resource(s) used in the (i+1)-th available time unit.

In some embodiments, different AMP devices use different manners to determine candidate frequency-domain resources for transmitting reference signals for ranging and/or positioning based on a dual-frequency phase difference. In other words, each AMP device uses an association relationship specific to the AMP device to determine a candidate frequency-domain resource for transmitting a reference signal for ranging and/or positioning based on a dual-frequency phase difference.

In some embodiments, different AMP devices transmit reference signals for ranging and/or positioning based on a dual-frequency phase difference in a manner of frequency-division multiplexing (FDM).

In some embodiments, the number of candidate frequency-domain resources for transmitting the reference signal by the AMP device in the same available time unit is one or more. Optionally, the available time unit may be configured by a network for the AMP device, or the available time unit may be preempted by the AMP device, or the available time unit may be preempted and shared with the AMP device by a network device.

For example, the AMP device may transmit the reference signal on only one candidate frequency-domain resource per available time unit.

For another example, the AMP device may transmit the reference signal on at least two candidate frequency-domain resources per available time unit.

For another example, the AMP device may transmit the reference signal on one candidate frequency-domain resource in part of available time units, and the AMP device may transmit the reference signal on at least two candidate frequency-domain resources in another part of available time units.

In some embodiments, the time unit is one of a symbol, a slot, a mini slot, a subframe, a second, a millisecond, and a microsecond.

In some embodiments, a candidate frequency-domain resource for transmitting the reference signal in the i-th available time unit is different from a candidate frequency-domain resource for transmitting the reference signal in the (i+1)-th available time unit, where i is an integer greater than or equal to 0. That is, transmission of the reference signal on different candidate frequency-domain resources is equivalent to frequency-hopping transmission of the reference signal.

In some embodiments, an interval between a candidate frequency-domain resource for transmitting the reference signal in the i-th available time unit and a candidate frequency-domain resource for transmitting the reference signal in the (i+1)-th available time unit is greater than or equal to X frequency-domain units, where X is a positive integer. Optionally, the frequency-domain unit is one of: a candidate frequency-domain resource, a channel, a system bandwidth, a carrier, a subcarrier, a PRB, a BWP, a MHz, a kHz, and a hertz (Hz). That is, X may be an absolute bandwidth, such as X MHz, X kHz, etc.; or may be a relative interval, such as X channels.

In some embodiments, the X frequency-domain units are predefined by a protocol. Alternatively, the X frequency-domain units are configured (which may be semi-statically configured or dynamically configured) by a network.

In some embodiments, in the case where the number of candidate frequency-domain resources for transmitting the reference signal by the AMP device in the same available time unit is one, a candidate frequency-domain resource used by the AMP device in the (i+1)-th available time unit is determined based on at least one of: a candidate frequency-domain resource used by the AMP device in the i-th available time unit, a hop interval, the total number of candidate frequency-domain resources in a deployment band corresponding to the AMP device, a smallest number of a candidate frequency-domain resource in the deployment band corresponding to the AMP device, or a largest number of a candidate frequency-domain resource in the deployment band corresponding to the AMP device.

Specifically, a unit of the hop interval may be a candidate frequency-domain resource. Certainly, the unit of the hop interval may also be another frequency-domain resource, and the embodiments of the disclosure are not limited in this regard.

In some embodiments, the hop interval is a fixed value. For example, the hop interval is fixed to one or more candidate frequency-domain resources.

In some embodiments, the hop interval is selected by looping in a first order from multiple preset hop intervals. Optionally, the first order is predefined by a protocol. Alternatively, the first order is configured (which may be semi-statically configured or dynamically configured) by a network.

Specifically, for example, the following four hop intervals (ΔF) are preconfigured: ΔF1, ΔF2, ΔF3, and ΔF4. That is, the multiple preset hop intervals are ΔF1, ΔF2, ΔF3, and ΔF4 .During frequency-hopping, the hop interval is sequentially selected by looping according to [ΔF1=>ΔF2=>ΔF3=>ΔF4=>ΔF1 . . . ].

In some embodiments, the hop interval is determined from the multiple preset hop intervals based on a value of i. For example, assuming that the number of the multiple preset hop intervals is L, the hop interval to be used is determined based on the following formula i mod L, where mod represents a modulo operation. For example, ΔF1 is selected when i mod L=y1, and ΔF2 is selected when i mod L=y2, where y1 and y2 are taken as examples, and there may be y3, y4, and the like, which is not limited herein. In addition, y1/y2 may be a single value or a set of multiple values.

In some embodiments, the hop interval is determined from the multiple preset hop intervals based on a value of a number of a frequency-domain resource used in the i-th available time unit. For example, assuming that the number of the multiple preset hop intervals is L, the hop interval to be used is determined based on the following formula y=i mod L, where y is the value of the number of the frequency-domain resource used in the i-th available time unit, and mod represents a modulo operation.

In some embodiments, the multiple preset hop intervals have positive values and/or negative values. For example, when multiple ΔF exist, values may be positive (“+”) and negative (“−”). For example, +2 and −2 may be used as two different values.

In some embodiments, the hop interval may also be referred to as an interval between candidate frequency-domain resources (for example, channels) in each two adjacent available time units.

In some embodiments, the candidate frequency-domain resource used by the AMP device in the (i+1)-th available time unit is determined based on the following formula 1:

$${F}^{( i + 1 )} = ( {F}^{( i )} + Δ F ) mod M \qquad formula 1$$

F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, M represents the total number of candidate frequency-domain resources in the deployment band corresponding to the AMP device, and mod represents a modulo operation.

It may be noted that, simple modifications can be made to the above formula 1, and the formula subject to the modifications also falls within the protection scope of the disclosure.

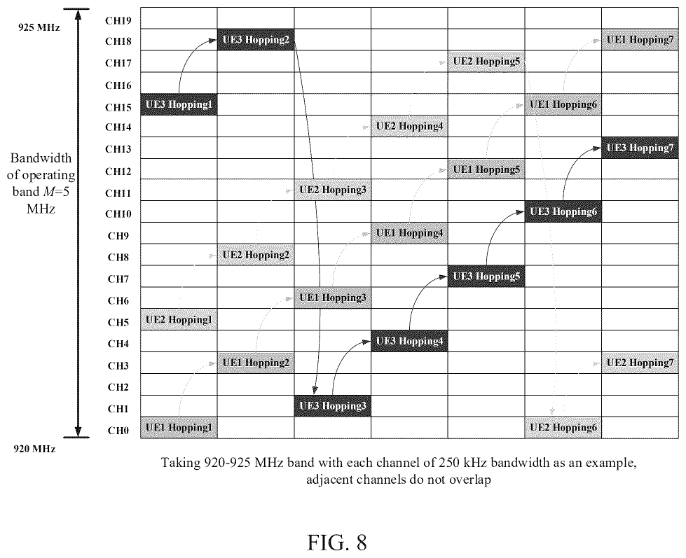

Specifically, for example, as illustrated in FIG. 8, it is assumed that a candidate frequency-domain resource is a channel (CH), the deployment band corresponding to the AMP device is 5 MHz (920-925 MHz), and a system bandwidth of 5 MHz (920-925 MHz) is divided into 20 channels each with a bandwidth of 250 kHz, i.e., M=20. The AMP device may be UE1, UE2, or UE3 illustrated in FIG. 8. Specifically, a candidate frequency-domain resource used in each available time unit may be determined based on the above formula 1. Herein, the first candidate frequency-domain resource initially selected by UE1 is CH0, the first candidate frequency-domain resource initially selected by UE2 is CH5, and the first candidate frequency-domain resource initially selected by UE3 is CH15.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula 2:

$${F}^{( r + 1 )} = ( {F}^{( r )} + Δ F ) mod M \qquad formula 2$$

In the case where F^{(r+1)} is an available candidate frequency-domain resource for the AMP device, F⁽ⁱ⁺¹⁾=F^{(r+1)}.

In the case where F^{(r+1)} is an unavailable candidate frequency-domain resource for the AMP device, r=r+1, and F^{(r+1)} is calculated based on updated r.

F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, and M represents the total number of candidate frequency-domain resources in the deployment band corresponding to the AMP device.

It may be noted that, simple modifications can be made to the above formula 2, and the formula subject to the modifications also falls within the protection scope of the disclosure.

Specifically, in practice, for all candidate frequency-domain resources (for example, channels) in the deployment band, all the candidate frequency-domain resources (for example, channels) may not be allocated to an AMP device. In other words, candidate frequency-domain resources that can be used by the AMP device are only part of the system resources. When a candidate frequency-domain resource(s) determined based on the above formula 2 is unavailable, the iterative selection of a subsequent candidate frequency-domain resource(s) based on formula 2 proceeds until an available candidate frequency-domain resource is selected.

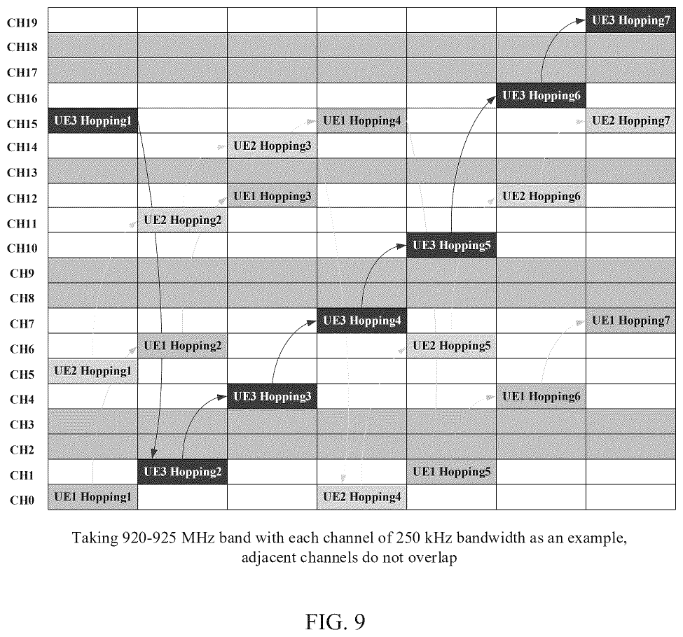

Specifically, for example, as illustrated in FIG. 9, it is assumed that a candidate frequency-domain resource is a CH, the deployment band corresponding to the AMP device is 5 MHz (920-925 MHz), and a system bandwidth of 5 MHz (920-925 MHz) is divided into 20 channels each with a bandwidth of 250 kHz, i.e., M=20. Different from FIG. 8, for UE1, UE2, and UE3, CH2, CH3, CH8, CH9, CH13, CH17, and CH18 among the 20 channels are unavailable. Specifically, a candidate frequency-domain resource used in each available time unit may be determined based on the above formula 2. Herein, the first candidate frequency-domain resource initially selected by UE1 is CH0, the first candidate frequency-domain resource initially selected by UE2 is CH5, and the first candidate frequency-domain resource initially selected by UE3 is CH15.

In some embodiments, the candidate frequency-domain resource used by the AMP device in the (i+1)-th available time unit is determined based on the following formula 3:

$${F}^{( i + 1 )} = ( {F}^{( i )} + Δ F ) mod ( q + 1 ) + p \qquad formula 3$$

F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, p represents the smallest number of the candidate frequency-domain resource in the deployment band corresponding to the AMP device, and q represents the largest number of the candidate frequency-domain resource in the deployment band corresponding to the AMP device.

$${F}^{( i )} satisfies p \leq {F}^{( i )} \leq q , and {F}^{( i + 1 )} satisfies p \leq {F}^{( i + 1 )} \leq q .$$

It may be noted that, simple modifications can be made to the above formula 3, and the formula subject to the modifications also falls within the protection scope of the disclosure.

Specifically, for example, it is assumed that a candidate frequency-domain resource is a CH, a smallest channel number in the deployment band corresponding to the AMP device is CH4 (i.e., p is CH4), and a largest channel number in the deployment band corresponding to the AMP device is CH23 (i.e., q is CH23). When ΔF=3, the above formula 3 may be CH⁽ⁱ⁺¹⁾=(CH⁽ⁱ⁾+3)mod 24+4. For example, in the case where a channel with number 4 is used in the i-th available time unit (CH⁽ⁱ⁾=CH4), channels used in subsequent available time units are CH7, CH10, CH13, CH16, CH19, CH22, and CH5 sequentially.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula 4:

$${F}^{( r + 1 )} = ( {F}^{( r )} + Δ F ) mod ( q + 1 ) + p \qquad formula 4$$

In the case where F^{(r+1)} is an available candidate frequency-domain resource for the AMP device, F⁽ⁱ⁺¹⁾=F^{(r+1)}.

In the case where F^{(r+1)} is an unavailable candidate frequency-domain resource for the AMP device, r=r+1, and F^{(r+1)} is calculated based on updated r.

F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, p represents the smallest number of the candidate frequency-domain resource in the deployment band corresponding to the AMP device, and q represents the largest number of the candidate frequency-domain resource in the deployment band corresponding to the AMP device.

$${F}^{( i )} satisfies p \leq {F}^{( i )} \leq q , and {F}^{( i + 1 )} satisfies p \leq {F}^{( i + 1 )} \leq q .$$

It may be noted that, simple modifications can be made to the above formula 4, and the formula subject to the modifications also falls within the protection scope of the disclosure.

Specifically, in practice, for all candidate frequency-domain resources (for example, channels) in the deployment band, all the candidate frequency-domain resources (for example, channels) may not be allocated to an AMP device. In other words, candidate frequency-domain resources that can be used by the AMP device are only part of the system resources. When a candidate frequency-domain resource(s) determined based on the above formula 4 is unavailable, the iterative selection of a subsequent candidate frequency-domain resource(s) based on formula 4 proceeds until an available candidate frequency-domain resource is selected.

In some embodiments, the candidate frequency-domain resource used by the AMP device in the (i+1)-th available time unit is determined based on the following formula 5:

$${F}^{( i + 1 )} = ( {F}^{( i )} + Δ F ) mod ( {q}_{k} + 1 ) + {p}_{k} \qquad formula 5$$

F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device;

$${F}^{( i )} satisfies {p}_{k} \leq {F}^{( i )} \leq {q}_{k} , and {F}^{( i + 1 )} satisfies {p}_{k} \leq {F}^{( i + 1 )} \leq {q}_{k} .$$

It may be noted that, simple modifications can be made to the above formula 5, and the formula subject to the modifications also falls within the protection scope of the disclosure.

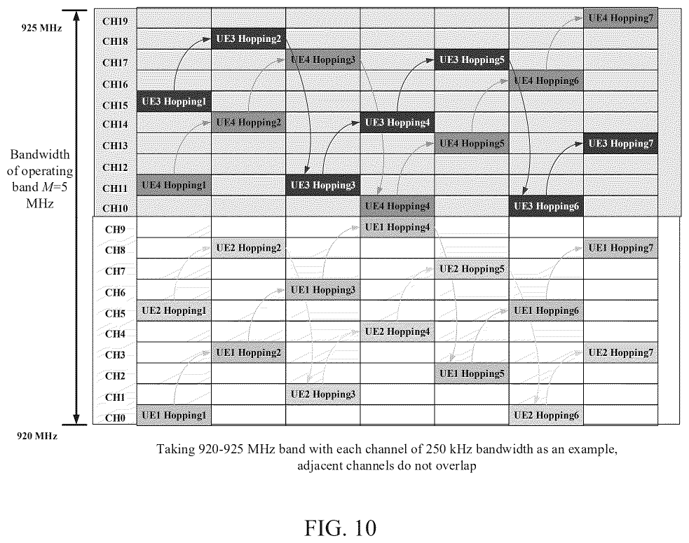

Specifically, for example, as illustrated in FIG. 10, it is assumed that a candidate frequency-domain resource is a CH, the deployment band corresponding to the AMP device is 5 MHz (920-925 MHz), and a system bandwidth of 5 MHz (920-925 MHz) is divided into 20 channels each with a bandwidth of 250 kHz, i.e., M=20. Available candidate frequency-domain resources in the deployment band are numbered from p to q. Candidate frequency-domain resources in this band may be grouped (into at least two groups). A position relationship between candidate frequency-domain resources in each two adjacent available time units in each group is similar to the scheme illustrated in FIG. 8. Taking two groups as an example, candidate frequency-domain resources in a first group are (p1 to q1), and candidate frequency-domain resources in a second group are (p2 to q2), where p1=p, p2=q1+1, and q2=q. Different from FIG. 8, UE1 and UE2 are both associated with one candidate frequency-domain resource set (CH0 to CH9), while UE3 and UE4 are both associated with another candidate frequency-domain resource set (CH10 to CH19). Specifically, a candidate frequency-domain resource used in each available time unit may be determined based on the above formula 5. Herein, the first candidate frequency-domain resource initially selected by UE1 is CH0, the first candidate frequency-domain resource initially selected by UE2 is CH5, the first candidate frequency-domain resource initially selected by UE3 is CH15, and the first candidate frequency-domain resource initially selected by UE4 is CH11.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula 6:

$${F}^{( r + 1 )} = ( {F}^{( r )} + Δ F ) mod ( {q}_{k} + 1 ) + {p}_{k} \qquad formula 6$$

In the case where F^{(r+1)} is an available candidate frequency-domain resource for the AMP device, F⁽ⁱ⁺¹⁾=F^{(r+1)}.

In the case where F^{(r+1)} is an unavailable candidate frequency-domain resource for the AMP device, r=r+1, and F^{(r+1)} is calculated based on updated r.

F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device.

$${F}^{( i )} satisfies {p}_{k} \leq {F}^{( i )} \leq {q}_{k} , and {F}^{( i + 1 )} satisfies {p}_{k} \leq {F}^{( i + 1 )} \leq {q}_{k} .$$

It may be noted that, simple modifications can be made to the above formula 6, and the formula subject to the modifications also falls within the protection scope of the disclosure.

Specifically, in practice, for all candidate frequency-domain resources (for example, channels) in the deployment band, all the candidate frequency-domain resources (for example, channels) may not be allocated to an AMP device. In other words, candidate frequency-domain resources that can be used by the AMP device are only part of the system resources. When a candidate frequency-domain resource(s) determined based on the above formula 6 is unavailable, the iterative selection of a subsequent candidate frequency-domain resource(s) based on formula 6 proceeds until an available candidate frequency-domain resource is selected.

In some embodiments, the candidate frequency-domain resource used by the AMP device in the (i+1)-th available time unit is determined based on the following formula 7:

$${F}^{( i + 1 )} = {F}^{( i )} + {( - 1 )}^{init} * {( - 1 )}^{S} Δ F \qquad formula 7$$

F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, a value of init is 0 or 1, and 4F represents the hop interval.

An initial value of S is 0, S=S+1 and F⁽ⁱ⁺¹⁾ is calculated based on updated S in the case where F⁽ⁱ⁾+(−1)^{init}*(−1)^{S}ΔF<p or F⁽ⁱ⁾+(−1)^{init}*(−1)^{S}ΔF>q, p represents the smallest number of the candidate frequency-domain resource in the deployment band corresponding to the AMP device, and q represents the largest number of the candidate frequency-domain resource in the deployment band corresponding to the AMP device.

$${F}^{( i )} satisfies p \leq {F}^{( i )} \leq q , and {F}^{( i + 1 )} satisfies p \leq {F}^{( i + 1 )} \leq q .$$

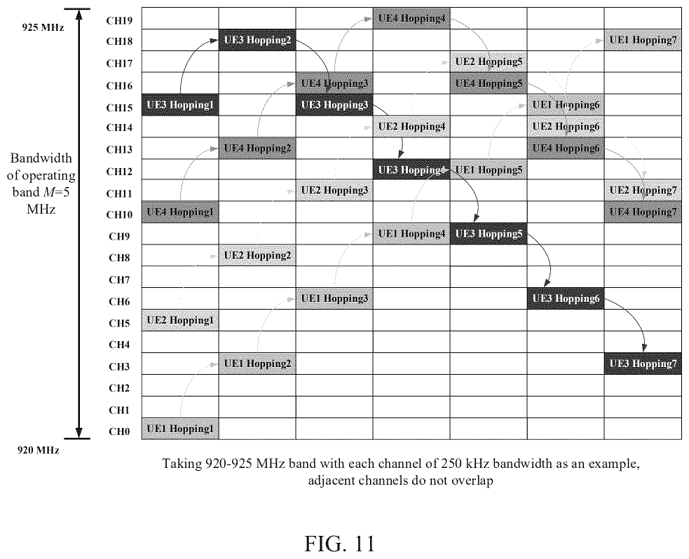

Specifically, for example, as illustrated in FIG. 11, it is assumed that a candidate frequency-domain resource is a CH, the deployment band corresponding to the AMP device is 5 MHz (920-925 MHz), and a system bandwidth of 5 MHz (920-925 MHz) is divided into 20 channels each with a bandwidth of 250 kHz. The AMP device may be UE1, UE2, UE3, or UE4 illustrated in FIG. 11. Specifically, a candidate frequency-domain resource used in each available time unit may be determined based on the above formula 7. Taking UE2 as an example, in the case where UE2 transmits a reference signal over CH5 at initialization, a value of init is 0, and ΔF=3, F⁽ⁱ⁺¹⁾=F⁽ⁱ⁾+(−1)^{init}*(−1)^{S}ΔF=F⁽ⁱ⁾+(−1)^{S}*3. Herein, F⁽⁰⁾=CH5, F⁽¹⁾=F⁽⁰⁾+(−1)⁰*3=CH8, F⁽²⁾=F⁽¹⁾+(−1)⁰*3=CH11, F⁽³⁾=F⁽²⁾+(−1)⁰*3=CH14, F⁽⁴⁾=F⁽³⁾+(−1)⁰*3=CH17, and since F⁽⁴⁾+(−1)⁰*3=CH30>CH19, S is updated to S=S+1=1, in this case, F⁽⁵⁾=F⁽⁴⁾+(−1)¹*3=CH14, F⁽⁶⁾=F⁽⁵⁾+(−1)¹*3=CH11. Other UEs in FIG. 11 are similar to UE2 and have a similar manner for determining a candidate frequency-domain resource used in an available time unit, which will not be repeated herein. In FIG. 11, the first candidate frequency-domain resource initially selected by UE1 is CH0, the first candidate frequency-domain resource initially selected by UE2 is CH5, the first candidate frequency-domain resource initially selected by UE3 is CH15, and the first candidate frequency-domain resource initially selected by UE4 is CH10.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula 8:

$${F}^{( r + 1 )} = {F}^{( r )} + {( - 1 )}^{init} * {( - 1 )}^{S} Δ F \qquad formula 8$$

In the case where F^{(r+1)} is an available candidate frequency-domain resource for the AMP device, F⁽ⁱ⁺¹⁾=F^{(r+1)}.

In the case where F^{(r+1)} is an unavailable candidate frequency-domain resource for the AMP device, r=r+1, and F^{(r+1)} is calculated based on updated r.

F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, a value of init is 0 or 1, and ΔF represents the hop interval.

An initial value of S is 0, S=S+1 and F⁽ⁱ⁺¹⁾ is calculated based on updated S in the case where F⁽ⁱ⁾+(−1)^{init}*(−1)^{S}ΔF<p or F⁽ⁱ⁾+(−1)^{init}*(−1)^{S}ΔF>q, p represents the smallest number of the candidate frequency-domain resource in the deployment band corresponding to the AMP device, and q represents the largest number of the candidate frequency-domain resource in the deployment band corresponding to the AMP device.

$${F}^{( i )} satisfies p \leq {F}^{( i )} \leq q , and {F}^{( i + 1 )} satisfies p \leq {F}^{( i + 1 )} \leq q .$$

It may be noted that, simple modifications can be made to the above formula 8, and the formula subject to the modifications also falls within the protection scope of the disclosure.

Specifically, in practice, for all candidate frequency-domain resources (for example, channels) in the deployment band, all the candidate frequency-domain resources (for example, channels) may not be allocated to an AMP device. In other words, candidate frequency-domain resources that can be used by the AMP device are only part of the system resources. When a candidate frequency-domain resource(s) determined based on the above formula 8 is unavailable, the iterative selection of a subsequent candidate frequency-domain resource(s) based on formula 8 proceeds until an available candidate frequency-domain resource is selected.

In some embodiments, the candidate frequency-domain resource used by the AMP device in the (i+1)-th available time unit is determined based on the following formula 9:

$${F}^{( i + 1 )} = {F}^{( i )} + {( - 1 )}^{init} * {( - 1 )}^{S} Δ F \qquad formula 9$$

F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, a value of init is 0 or 1, and ΔF represents the hop interval;

In a candidate frequency-domain resource set k associated with the AMP device in the deployment band corresponding to the AMP device, an initial value of S is 0, S=S+1 and F⁽ⁱ⁺¹⁾ is calculated based on updated S in the case where F⁽ⁱ⁾+(−1)^{init}*(−1)^{S}ΔF<pₖ or F⁽ⁱ⁾+(−1)^{init}*(−1)^{S}ΔF>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device;

$${F}^{( i )} satisfies {p}_{k} \leq {F}^{( i )} \leq {q}_{k} , and {F}^{( i + 1 )} satisfies {p}_{k} \leq {F}^{( i + 1 )} \leq {q}_{k} .$$

It may be noted that, simple modifications can be made to the above formula 9, and the formula subject to the modifications also falls within the protection scope of the disclosure.

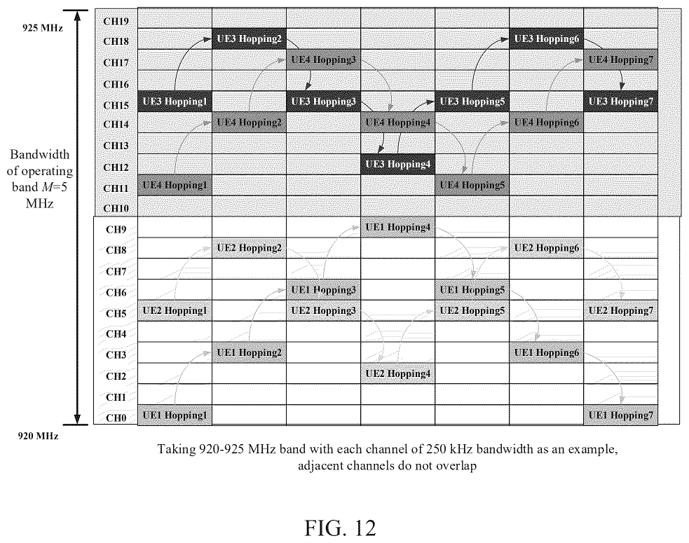

Specifically, for example, as illustrated in FIG. 12, it is assumed that a candidate frequency-domain resource is a CH, the deployment band corresponding to the AMP device is 5 MHz (920-925 MHz), and a system bandwidth of 5 MHz (920-925 MHz) is divided into 20 channels each with a bandwidth of 250 kHz. Available candidate frequency-domain resources in the deployment band are numbered from p to q. Candidate frequency-domain resources in this band may be grouped (into at least two groups). A position relationship between candidate frequency-domain resources in each two adjacent available time units in each group is similar to the scheme illustrated in FIG. 11. Taking two groups as an example, candidate frequency-domain resources in a first group are (p1 to q1), and candidate frequency-domain resources in a second group are (p2 to q2), where p1=p, p2=q1+1, and q2=q. Different from FIG. 11, UE1 and UE2 are both associated with one candidate frequency-domain resource set (CH0 to CH9), while UE3 and UE4 are both associated with another candidate frequency-domain resource set (CH10 to CH19). Specifically, a candidate frequency-domain resource used in each available time unit may be determined based on the above formula 9. Herein, the first candidate frequency-domain resource initially selected by UE1 is CH0, the first candidate frequency-domain resource initially selected by UE2 is CH5, the first candidate frequency-domain resource initially selected by UE3 is CH15, and the first candidate frequency-domain resource initially selected by UE4 is CH11.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula 10:

$${F}^{( r + 1 )} = {F}^{( r )} + {( - 1 )}^{init} * {( - 1 )}^{S} Δ F \qquad formula 10$$

In the case where F^{(r+1)} is an available candidate frequency-domain resource for the AMP device, F⁽ⁱ⁺¹⁾=F^{(r+1)}.

In the case where F^{(r+1)} is an unavailable candidate frequency-domain resource for the AMP device, r=r+1, and F^{(r+1)} is calculated based on updated r.

F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, a value of init is 0 or 1, and ΔF represents the hop interval.

In a candidate frequency-domain resource set k associated with the AMP device in the deployment band corresponding to the AMP device, an initial value of S is 0, S=S+1 and F⁽ⁱ⁺¹⁾ is calculated based on updated S in the case where F⁽ⁱ⁾+(−1)^{init}*(−1)^{S}ΔF<pₖ or F⁽ⁱ⁾+(−1)^{init}*(−1)^{S}ΔF>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device.

$${F}^{( i )} satisfies {p}_{k} \leq {F}^{( i )} \leq {q}_{k} , and {F}^{( i + 1 )} satisfies {p}_{k} \leq {F}^{( i + 1 )} \leq {q}_{k} .$$

It may be noted that, simple modifications can be made to the above formula 10, and the formula subject to the modifications also falls within the protection scope of the disclosure.

Specifically, in practice, for all candidate frequency-domain resources (for example, channels) in the deployment band, all the candidate frequency-domain resources (for example, channels) may not be allocated to an AMP device. In other words, candidate frequency-domain resources that can be used by the AMP device are only part of the system resources. When a candidate frequency-domain resource(s) determined based on the above formula 10 is unavailable, the iterative selection of a subsequent candidate frequency-domain resource(s) based on formula 10 proceeds until an available candidate frequency-domain resource is selected.

In some embodiments, in formula 7 to formula 10 above, in the case where S=S+1 and multiple preset hop intervals exist, the AMP device selects the hop interval from the multiple preset hop intervals based on a preset order. Optionally, the same configuration manner is used for both the preset order and the multiple preset hop intervals, for example, both are protocol-predefined parameters or network-configured parameters.

Specifically, for example, the preset order may be an ascending order of hop intervals, or the preset order may be a descending order of hop intervals, or the preset order may be an ascending order of numbers (indexes) of hop intervals, or the preset order may be a descending order of numbers of hop intervals, or may be another order.

In some embodiments, in the case where the number of candidate frequency-domain resources for transmitting the reference signal by the AMP device in the same available time unit is multiple, the j-th candidate frequency-domain resource used by the AMP device in the (i+1)-th available time unit is determined based on at least one of: the j-th candidate frequency-domain resource used by the AMP device in the i-th available time unit, a hop interval associated with the j-th candidate frequency-domain resource, the total number of candidate frequency-domain resources in a deployment band corresponding to the AMP device, a smallest number of a candidate frequency-domain resource in the deployment band corresponding to the AMP device, or a largest number of a candidate frequency-domain resource in the deployment band corresponding to the AMP device. j is a positive integer.

In some embodiments, the multiple candidate frequency-domain resources for transmitting the reference signal by the AMP device in the same available time unit are continuous, or the multiple candidate frequency-domain resources for transmitting the reference signal by the AMP device in the same available time unit are discontinuous.

Specifically, the multiple candidate frequency-domain resources for transmitting the reference signal in the same available time unit may be referred to as a bundled candidate frequency-domain resource set.

In some embodiments, the hop interval associated with the j-th candidate frequency-domain resource is a fixed value. For example, the hop interval associated with the j-th candidate frequency-domain resource is fixed to one or more candidate frequency-domain resources.

In some embodiments, the hop interval associated with the j-th candidate frequency-domain resource is selected by looping in a second order from multiple preset hop intervals. Optionally, the second order is predefined by a protocol. Alternatively, the first order is configured (which may be semi-statically configured or dynamically configured) by a network.

Specifically, for example, the following four hop intervals (ΔF) are preconfigured: ΔF1, ΔF2, ΔF3, and ΔF4. That is, the multiple preset hop intervals are ΔF1, ΔF2, ΔF3, and ΔF4. During frequency-hopping, the hop interval associated with the j-th candidate frequency-domain resource is sequentially selected by looping according to [ΔF1=>ΔF2=>ΔF3=>ΔF4=>ΔF1 . . . ].

In some embodiments, the hop interval associated with the j-th candidate frequency-domain resource is determined from the multiple preset hop intervals based on a value of i. For example, assuming that the number of the multiple preset hop intervals is L, the hop interval to be used is determined based on the following formula i mod L, where mod represents a modulo operation. For another example, ΔF1 is selected when i mod L=y1, and ΔF2 is selected when i mod L=y2, where y1 and y2 are taken as examples, and there may be y3, y4, and the like, which is not limited herein. In addition, y1/y2 may be a single value or a set of multiple values.

In some embodiments, the hop interval associated with the j-th candidate frequency-domain resource is determined from the multiple preset hop intervals based on a value of a number of the j-th candidate frequency-domain resource used in the i-th available time unit. For example, assuming that the number of the multiple preset hop intervals is L, the hop interval to be used is determined based on the following formula y mod L, where y is the value of the number of the frequency-domain resource used in the i-th available time unit, and mod represents a modulo operation.

In some embodiments, the multiple preset hop intervals have positive values and/or negative values. For example, when multiple ΔF exist, values may be positive (“+”) and negative (“−”). For example, +2 and −2 may be used as two different values.

In some embodiments, the hop interval may also be referred to as an interval between candidate frequency-domain resources (for example, channels) in each two adjacent available time units.

In some embodiments, the j-th candidate frequency-domain resource used by the AMP device in the (i+1)-th available time unit is determined based on the following formula 11:

$${F}^{( i + 1 ) \_ j} = ( {F}^{( i ) \_ j} + Δ {F}^{′} ) mod M \qquad formula 11$$

F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, and M represents the total number of candidate frequency-domain resources in the deployment band corresponding to the AMP device.

It may be noted that, simple modifications can be made to the above formula 11, and the formula subject to the modifications also falls within the protection scope of the disclosure.

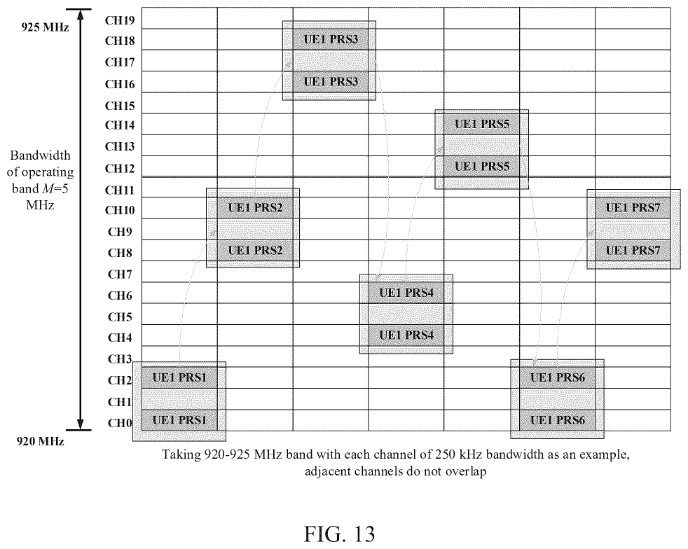

Specifically, for example, it is assumed that a candidate frequency-domain resource is a CH, the deployment band corresponding to the AMP device is 5 MHz (920-925 MHz), and a system bandwidth of 5 MHz (920-925 MHz) is divided into 20 channels each with a bandwidth of 250 kHz, i.e., M=20. As illustrated in FIG. 13, the AMP device is UE1. In particular, UE1 transmits a reference signal (which may be referred to as UE1 PRS1) on CH0 and CH2 in the first available time unit. UE1 transmits a reference signal (which may be referred to as UE1 PRS2) on CH8 and CH10 in the second available time unit, where CH8 is calculated by substituting CH0 into formula 11, and CH10 is calculated by substituting CH2 into formula 11. UE1 transmits a reference signal (which may be referred to as UE1 PRS3) on CH16 and CH18 in the third available time unit, where CH16 is calculated by substituting CH8 into formula 11, and CH18 is calculated by substituting CH10 into formula 11. UE1 transmits a reference signal (which may be referred to as UE1 PRS4) on CH4 and CH6 in the fourth available time unit, where CH4 is calculated by substituting CH16 into formula 11, and CH6 is calculated by substituting CH18 into formula 11. UE1 transmits a reference signal (which may be referred to as UE1 PRS5) on CH12 and CH14 in the fifth available time unit, where CH12 is calculated by substituting CH4 into formula 11, and CH14 is calculated by substituting CH6 into formula 11. UE1 transmits a reference signal (which may be referred to as UE1 PRS6) on CH0 and CH2 in the sixth available time unit, where CH0 is calculated by substituting CH12 into formula 11, and CH2 is calculated by substituting CH14 into formula 11. UE1 transmits a reference signal (which may be referred to as UE1 PRS7) on CH8 and CH10 in the seventh available time unit, where CH8 is calculated by substituting CH0 into formula 11, and CH10 is calculated by substituting CH2 into formula 11.

In some embodiments, the j-th candidate frequency-domain resource used by the AMP device in the (i+1)-th available time unit is determined based on the following formula 12:

$${F}^{( i + 1 ) \_ j} = ( {F}^{( i ) \_ j} + Δ {F}^{′} ) mod ( q + 1 ) + p \qquad formula 12$$

F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, p represents the smallest number of the candidate frequency-domain resource in the deployment band corresponding to the AMP device, and q represents the largest number of the candidate frequency-domain resource in the deployment band corresponding to the AMP device.

$${F}^{( i ) \_ j} satisfies p \leq {F}^{( i ) \_ j} \leq q , and {F}^{( i + 1 ) \_ j} satisfies p \leq {F}^{( i + 1 ) \_ j} \leq q .$$

In some embodiments, the j-th candidate frequency-domain resource used by the AMP device in the (i+1)-th available time unit is determined based on the following formula 13:

$${F}^{( i + 1 ) \_ j} = ( {F}^{( i ) \_ j} + Δ {F}^{′} ) mod ( {q}_{k} + 1 ) + {p}_{k} \qquad formula 13$$

F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device;

$${F}^{( i ) \_ j} satisfies {p}_{k} \leq {F}^{( i ) \_ j} \leq {q}_{k} , and \\ {F}^{( i + 1 ) \_ j} satisfies {p}_{k} \leq {F}^{( i + 1 ) \_ j} \leq {q}_{k} .$$

In some embodiments, the j-th candidate frequency-domain resource used by the AMP device in the (i+1)-th available time unit is determined based on the following formula 14:

$${F}^{( i + 1 ) \_ j} = {F}^{( i ) \_ j} + {( - 1 )}^{init} * {( - 1 )}^{S} Δ {F}^{′} \qquad formula 14$$

F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, a value of init is 0 or 1, and ΔF′ represents the hop interval associated with the j-th candidate frequency-domain resource.

An initial value of S is 0, S=S+1 and F^{(i+1)_j} is calculated based on updated S in the case where F^{(i)_j}+(−1)^{init}*(−1)^{S}ΔF′<p or F^{(i)_j}+(−1)^{init}*(−1)^{S}ΔF′>q, p represents the smallest number of the candidate frequency-domain resource in the deployment band corresponding to the AMP device, and q represents the largest number of the candidate frequency-domain resource in the deployment band corresponding to the AMP device.

$${F}^{( i ) \_ j} satisfies p \leq {F}^{( i ) \_ j} \leq q , and \\ {F}^{( i + 1 ) \_ j} satisfies p \leq {F}^{( i + 1 ) \_ j} \leq q .$$

In some embodiments, the j-th candidate frequency-domain resource used by the AMP device in the (i+1)-th available time unit is determined based on the following formula 15:

$${F}^{( i + 1 ) \_ j} = {F}^{( i ) \_ j} + {( - 1 )}^{init} * {( - 1 )}^{S} Δ {F}^{′} \qquad formula 15$$

F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, a value of init is 0 or 1, and ΔF′ represents the hop interval associated with the j-th candidate frequency-domain resource;

In a candidate frequency-domain resource set k associated with the AMP device in the deployment band corresponding to the AMP device, an initial value of S is 0, S=S+1 and F^{(i+1)_j} is calculated based on updated S in the case where F^{(i)_j}+(−1)^{init}*(−1)^{S}ΔF′<pₖ or F^{(i)_j}+(−1)^{init}*(−1)^{S}ΔF′>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device;

$${F}^{( i ) \_ j} satisfies {p}_{k} \leq {F}^{( i ) \_ j} \leq {q}_{k} , and \\ {F}^{( i + 1 ) \_ j} satisfies {p}_{k} \leq {F}^{( i + 1 ) \_ j} \leq {q}_{k} .$$

In some embodiments, in formula 14 and formula 15 above, in the case where S=S+1 and multiple preset hop intervals exist, the AMP device selects the hop interval from the multiple preset hop intervals based on a preset order. Optionally, the same configuration manner is used for both the preset order and the multiple preset hop intervals, for example, both are protocol-predefined parameters or network-configured parameters.

Specifically, for example, the preset order may be an ascending order of hop intervals, or the preset order may be a descending order of hop intervals, or the preset order may be an ascending order of numbers of hop intervals, or the preset order may be a descending order of numbers of hop intervals, or may be another order.

It may be noted that, simple modifications can be made to the above formulas 11 to 15, and the formulas subject to the modifications also fall within the protection scope of the disclosure.

In some embodiments, in the case where the number of candidate frequency-domain resources for transmitting the reference signal by the AMP device in the same available time unit is one, an available candidate frequency-domain resource used by the AMP device in the (i+1)-th available time unit is determined based on at least one of: an available candidate frequency-domain resource used by the AMP device in the i-th available time unit, a hop interval, the total number of available candidate frequency-domain resources for the AMP device in a deployment band corresponding to the AMP device, a smallest relative number of an available candidate frequency-domain resource for the AMP device in the deployment band corresponding to the AMP device, or a largest relative number of an available candidate frequency-domain resource for the AMP device in the deployment band corresponding to the AMP device.

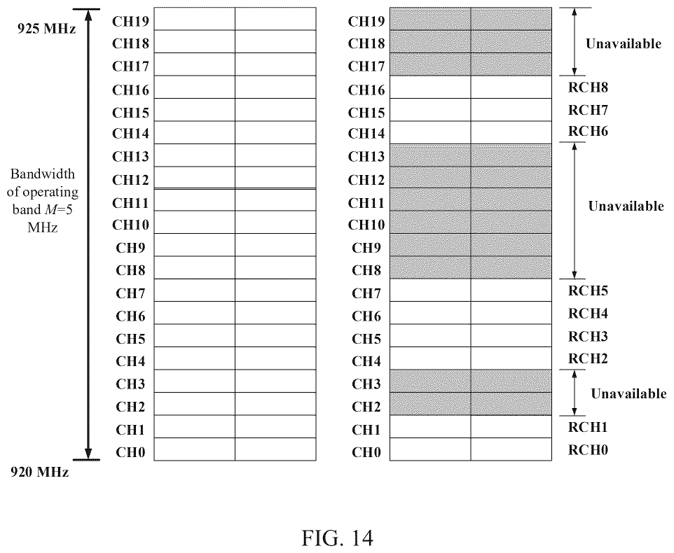

Specifically, in practice, for all candidate frequency-domain resources (for example, channels) in the deployment band, all the candidate frequency-domain resources (for example, channels) may not be allocated to an AMP device. That is, candidate frequency-domain resources that can be used by the AMP device are only part of the system resources, and a relative number (for example, a relative channel (RCH)) of each available candidate frequency-domain resource can be obtained based on a candidate frequency-domain resource(s) actually available to the AMP device. Specifically, assuming that a candidate frequency-domain resource is a CH, the deployment band corresponding to the AMP device is 5 MHz (920-925 MHz), and a system bandwidth of 5 MHz (920-925 MHz) is divided into 20 channels each with a bandwidth of 250 kHz. As illustrated in FIG. 14, CH2, CH3, CH8, CH9, CH10, CH11, CH12, CH13, CH17, CH18, and CH19 are channels unavailable to the AMP device, and relative numbers (i.e., RCH0 to RCH8) of all available candidate frequency-domain resources can be obtained based on candidate frequency-domain resources (i.e., CH0, CH1, CH4, CH5, CH6, CH7, CH14, CH15, and CH16) actually available to the AMP device.

Specifically, a unit of the hop interval may be a candidate frequency-domain resource. Certainly, the unit of the hop interval may also be another frequency-domain resource, and the embodiments of the disclosure are not limited in this regard.

In some embodiments, the hop interval is a fixed value, or the hop interval is selected by looping in a first order from multiple preset hop intervals, or the hop interval is determined from the multiple preset hop intervals based on a value of i, or the hop interval is determined from the multiple preset hop intervals based on a value of a relative number of the available candidate frequency-domain resource used in the i-th available time unit.

In some embodiments, the available candidate frequency-domain resource used by the AMP device in the (i+1)-th available time unit is determined based on the following formula 16:

$${F}^{( i + 1 )} = ( {F}^{( i )} + Δ F ) mod {M}^{′} \qquad formula 16$$

F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, ΔF represents the hop interval, and M′ represents the total number of available candidate frequency-domain resources for the AMP device in the deployment band corresponding to the AMP device.

In some embodiments, the available candidate frequency-domain resource used by the AMP device in the (i+1)-th available time unit is determined based on the following formula 17:

$${F}^{( i + 1 )} = ( {F}^{( i )} + Δ F ) mod ( {q}^{′} + 1 ) + {p}^{′} \qquad formula 17$$

F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, ΔF represents the hop interval, p′ represents the smallest relative number of the available candidate frequency-domain resource for the AMP device in the deployment band corresponding to the AMP device, and q′ represents the largest relative number of the available candidate frequency-domain resource for the AMP device in the deployment band corresponding to the AMP device.

$${F}^{( i )} satisfies {p}^{′} \leq {F}^{( i )} \leq {q}^{′} , and \\ {F}^{( i + 1 )} satisfies {p}^{′} \leq {F}^{( i + 1 )} \leq {q}^{′} .$$

In some embodiments, the available candidate frequency-domain resource used by the AMP device in the (i+1)-th available time unit is determined based on the following formula 18:

$${F}^{( i + 1 )} = ( {F}^{( i )} + Δ F ) mod ( {q}_{k}^{′} + 1 ) + {p}_{k}^{′} \qquad formula 18$$

F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, ΔF represents the hop interval, pₖ′ represents a smallest relative number of an available candidate frequency-domain resource in a candidate frequency-domain resource set k associated with the AMP device in the deployment band corresponding to the AMP device, and qₖ′ represents a largest relative number of an available candidate frequency-domain resource in the candidate frequency-domain resource set k associated with the AMP device in the deployment band corresponding to the AMP device;

$${F}^{( i )} satisfies {p}_{k}^{′} \leq {F}^{( i )} \leq {q}_{k}^{′} , and \\ {F}^{( i + 1 )} satisfies {p}_{k}^{′} \leq {F}^{( i + 1 )} \leq {q}_{k}^{′} .$$

In some embodiments, the available candidate frequency-domain resource used by the AMP device in the (i+1)-th available time unit is determined based on the following formula 19:

$${F}^{( i + 1 )} = {F}^{( i )} + {( - 1 )}^{init} * {( - 1 )}^{S} Δ F \qquad formula 19$$

F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, a value of init is 0 or 1, and ΔF represents the hop interval.

An initial value of S is 0, S=S+1 and F⁽ⁱ⁺¹⁾ is calculated based on updated S in the case where F⁽ⁱ⁾+(−1)^{init}*(−1)^{S}ΔF<p′ and F⁽ⁱ⁾+(−1)^{init}*(−1)^{S}ΔF>q′, p′ represents the smallest relative number of the available candidate frequency-domain resource for the AMP device in the deployment band corresponding to the AMP device, and q′ represents the largest relative number of the available candidate frequency-domain resource for the AMP device in the deployment band corresponding to the AMP device.

$${F}^{( i )} satisfies {p}^{′} \leq {F}^{( i )} \leq {q}^{′} , and \\ {F}^{( i + 1 )} satisfies {p}^{′} \leq {F}^{( i + 1 )} \leq {q}^{′} .$$

In some embodiments, the available candidate frequency-domain resource used by the AMP device in the (i+1)-th available time unit is determined based on the following formula 20:

$${F}^{( i + 1 )} = {F}^{( i )} + {( - 1 )}^{init} * {( - 1 )}^{S} Δ F \qquad formula 20$$

F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, a value of init is 0 or 1, and ΔF represents the hop interval.

In a candidate frequency-domain resource set k associated with the AMP device in the deployment band corresponding to the AMP device, an initial value of S is 0, S=S+1 and F⁽ⁱ⁺¹⁾ is calculated based on updated S in the case where F⁽ⁱ⁾+(−1)^{init}*(−1)^{S}ΔF<pₖ′ or F⁽ⁱ⁾+(−1)^{init}*(−1)^{S}ΔF>qₖ′, pₖ′ represents a smallest relative number of an available candidate frequency-domain resource in the candidate frequency-domain resource set k associated with the AMP device, and qₖ′ represents a largest relative number of an available candidate frequency-domain resource in the candidate frequency-domain resource set k associated with the AMP device.

$${F}^{( i )} satisfies {p}_{k}^{′} \leq {F}^{( i )} \leq {q}_{k}^{′} , and \\ {F}^{( i + 1 )} satisfies {p}_{k}^{′} \leq {F}^{( i + 1 )} \leq {q}_{k}^{′} .$$

In some embodiments, in formula 16 and formula 20 above, in the case where S=S+1 and multiple preset hop intervals exist, the AMP device selects the hop interval from the multiple preset hop intervals based on a preset order. Optionally, the same configuration manner is used for both the preset order and the multiple preset hop intervals, for example, both are protocol-predefined parameters or network-configured parameters.

Specifically, for example, the preset order may be an ascending order of hop intervals, or the preset order may be a descending order of hop intervals, or the preset order may be an ascending order of numbers of hop intervals, or the preset order may be a descending order of numbers of hop intervals, or may be another order.

It may be noted that, simple modifications can be made to the above formulas 16 to 20, and the formulas subject to the modifications also fall within the protection scope of the disclosure.

In some embodiments, an available candidate frequency-domain resource for the AMP device in the deployment band corresponding to the AMP device is configured by a network. Alternatively, the available candidate frequency-domain resource for the AMP device in the deployment band corresponding to the AMP device is preempted and shared with the AMP device by a network device. Alternatively, the available candidate frequency-domain resource for the AMP device in the deployment band corresponding to the AMP device is preempted by the AMP device.

In some embodiments, in formula 7 to formula 10, formula 14, formula 15, formula 19, and formula 20 above, the value (0 or 1) of init is randomly determined by the AMP device. Alternatively, the value of init is configured (dynamically configured/semi-statically configured) by a network. Alternatively, the value of init is determined based on a position of the first candidate frequency-domain resource initially selected (for example, when the position of the first candidate frequency-domain resource is less than a threshold, init=0, and otherwise, init=1). Alternatively, the value of init is determined based on an identifier of the AMP device and/or an identifier of the receiver (i.e., the communication device).

In some embodiments, the candidate frequency-domain resource set k associated with the AMP device is a candidate frequency-domain resource set configured or indicated by a network among multiple candidate frequency-domain resource sets in the deployment band corresponding to the AMP device.

In some embodiments, the candidate frequency-domain resource set k associated with the AMP device is determined from the multiple candidate frequency-domain resource sets in the deployment band corresponding to the AMP device based on an identifier of the AMP device and/or an identifier of a group to which the AMP device belongs. For example, assuming that the number of the multiple candidate frequency-domain resource sets is V, the candidate frequency-domain resource set k is determined based on the following formula ID mod V or Group_ID mod V, where mod represents a modulo operation. For example, the first candidate frequency-domain resource set is selected when ID mod V=z1, the second candidate frequency-domain resource set is selected when ID mod V=z2, and so on, where z1 and z2 are taken as examples, and there may be z3, z4, and the like, which is not limited herein. In addition, z1/z2 may be a single value or a set of multiple values.

In some embodiments, the candidate frequency-domain resource set k associated with the AMP device is determined from the multiple candidate frequency-domain resource sets in the deployment band corresponding to the AMP device based on a number of the first candidate frequency-domain resource initially selected by the AMP device. For example, in the case where the number of the first candidate frequency-domain resource initially selected by the AMP device is located in candidate frequency-domain resource set 0, a candidate frequency-domain resource set associated with the AMP device is candidate frequency-domain resource set 0; in the case where the number of the first candidate frequency-domain resource initially selected by the AMP device is located in candidate frequency-domain resource set 1, a candidate frequency-domain resource set associated with the AMP device is candidate frequency-domain resource set 1; and so on.

In some embodiments, the first candidate frequency-domain resource initially selected by the AMP device is randomly selected, or the first candidate frequency-domain resource initially selected by the AMP device is configured by a network, or the first candidate frequency-domain resource initially selected by the AMP device is determined based on an identifier of the AMP device and/or an identifier of a peer device.

For example, the first candidate frequency-domain resource initially selected by the AMP device is associated with the identifier of the AMP device and/or the identifier of the peer device (i.e., an identifier of the communication device). For example, the first candidate frequency-domain resource initially selected by the AMP device is determined based on the following formula: ID mod(q+1)+p, where p represents a smallest number of a candidate frequency-domain resource in a deployment band corresponding to the AMP device, and q represents a largest number of a candidate frequency-domain resource in the deployment band corresponding to the AMP device.

In some embodiments, the N candidate frequency-domain resources are determined based on at least one hopping pattern. Optionally, the at least one hopping pattern is predefined by a protocol, or the at least one hopping pattern is configured (dynamically configured/semi-statically configured) by a network.

Specifically, for example, a network device may indicate the N candidate frequency-domain resources via a bitmap, for example, there are 10 available candidate frequency-domain resources in total, and each bit corresponds to one available candidate frequency-domain resource. The AMP device performs frequency-hopping on these frequency-domain resources according to a preset rule, for example, from low to high or from high to low. Alternatively, the network device configures/the AMP device determines the first frequency-domain resource to be used, and subsequently, frequency-domain resources are repeatedly used (for example, in the case where the network device indicates to use CH1/CH4/CH6/CH9/CH15, and the AMP device may determine to use CH6 for the first time, frequency-hopping is performed in an order of CH6=>CH9=>CH15=>CH1=>CH4).

Optionally, the N candidate frequency-domain resources may be determined based on a combination of multiple semi-statically configured hopping patterns, and the network device indicates indexes of the configured hopping patterns.

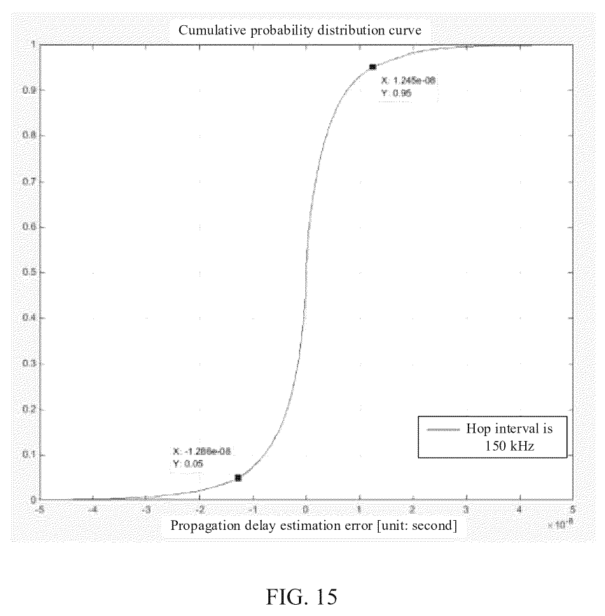

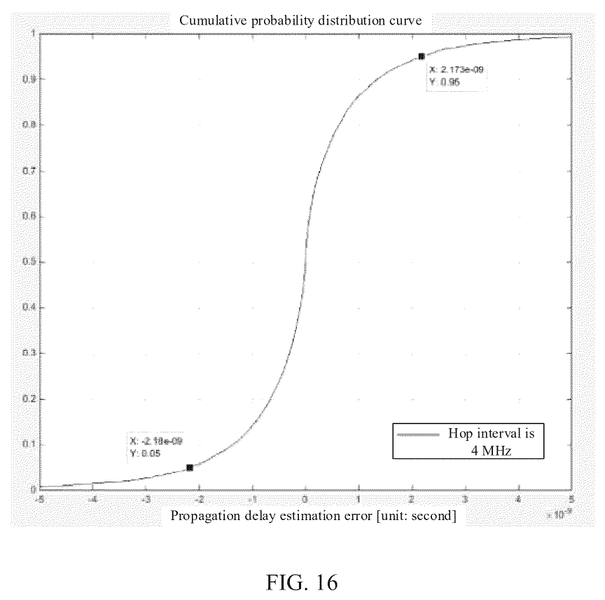

In embodiments of the disclosure, in order to verify the influence of a frequency-hopping distance on estimation performance of propagation time (such as time of arrival (TOA))/propagation distance, TOA estimation for reference signals of different frequency hops may be simulated, and errors from the TOA estimation are statistically drawn into cumulative distribution function (CDF) curves as illustrated in FIG. 15 and FIG. 16. As can be seen from the simulation result, compared with intra-channel frequency-hopping with a smaller frequency-hopping distance, the performance of TOA estimation is significantly improved when an inter-channel frequency-hopping scheme with a larger frequency-hopping distance is used. Therefore, advantages of frequency-hopping (for example, inter-channel frequency-hopping) in embodiments of the disclosure are verified. Herein, a horizontal coordinate axis represents a difference between measured TOA and actual TOA, and since no absolute value is taken in the simulation, the result includes positive values and negative values; and a vertical coordinate axis represents a cumulative probability value. Specifically, in FIG. 15, in intra-channel frequency-hopping, a frequency-hopping distance is 40 subcarriers (150 kHz), which is very close to a channel bandwidth (48 subcarriers) of a PRACH. As can be seen, in the intra-channel frequency-hopping scheme, a propagation time (such as TOA) estimation error is approximately 12 nanoseconds (ns) (corresponding to values at 5% and 95%, which indicates that the performance is better than 12 ns for 90% therebetween), and a corresponding distance error is 3.6 m. In FIG. 16, in inter-channel frequency-hopping, a frequency-hopping distance is 4 MHz, a propagation time (such as TOA) estimation error is approximately 2.2 ns, and a corresponding distance error is 0.7 m.

Therefore, in embodiments of the disclosure, the communication device can determine the position of the AMP device based on the reference signal transmitted on the N candidate frequency-domain resources, or the communication device can determine the position of the receiver (i.e., the communication device) of the reference signal based on the reference signal transmitted on the N candidate frequency-domain resources; and/or, the communication device can determine the distance between the AMP device and the receiver (i.e., the communication device) of the reference signal based on the reference signal transmitted on the N candidate frequency-domain resources.

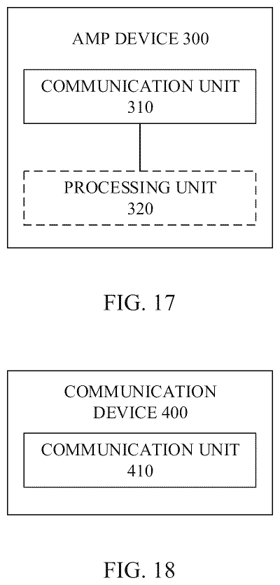

The method embodiments of the disclosure are described in detail above with reference to FIG. 7 to FIG. 16, and apparatus embodiments of the disclosure will be described in detail below with reference to FIG. 17 to FIG. 21. It may be understood that the apparatus embodiments correspond to the method embodiments, and for similar illustrations, reference can be made to the method embodiments.

FIG. 17 is a schematic block diagram of an AMP device 300 according to embodiments of the disclosure. As illustrated in FIG. 17, the AMP device 300 includes a communication unit 310. The communication unit 310 is configured to transmit a reference signal on N candidate frequency-domain resources. The reference signal transmitted on the N candidate frequency-domain resources is used to determine a position of the AMP device or a position of a receiver of the reference signal, and/or the reference signal transmitted on the N candidate frequency-domain resources is used to determine a distance between the AMP device and the receiver of the reference signal. N is a positive integer and N≥2.

In some embodiments, the number of candidate frequency-domain resources for transmitting the reference signal by the AMP device in the same available time unit is one or more.

In some embodiments, a candidate frequency-domain resource for transmitting the reference signal in the i-th available time unit is different from a candidate frequency-domain resource for transmitting the reference signal in the (i+1)-th available time unit, where i is an integer greater than or equal to 0.

In some embodiments, an interval between a candidate frequency-domain resource for transmitting the reference signal in the i-th available time unit and a candidate frequency-domain resource for transmitting the reference signal in the (i+1)-th available time unit is greater than or equal to X frequency-domain units, where X is a positive integer.

In some embodiments, the frequency-domain unit is one of: a candidate frequency-domain resource, a channel, a system bandwidth, a carrier, a subcarrier, a PRB, a BWP, a MHz, a kHz, and a Hz.

In some embodiments, in the case where the number of candidate frequency-domain resources for transmitting the reference signal by the AMP device in the same available time unit is one, a candidate frequency-domain resource used by the AMP device in the (i+1)-th available time unit is determined based on at least one of: a candidate frequency-domain resource used by the AMP device in the i-th available time unit, a hop interval, the total number of candidate frequency-domain resources in a deployment band corresponding to the AMP device, a smallest number of a candidate frequency-domain resource in the deployment band corresponding to the AMP device, or a largest number of a candidate frequency-domain resource in the deployment band corresponding to the AMP device.

In some embodiments, the hop interval is a fixed value, or the hop interval is selected by looping in a first order from multiple preset hop intervals, or the hop interval is determined from the multiple preset hop intervals based on a value of i, or the hop interval is determined from the multiple preset hop intervals based on a value of a number of a frequency-domain resource used in the i-th available time unit.

In some embodiments, the candidate frequency-domain resource used by the AMP device in the (i+1)-th available time unit is determined based on the following formula: F⁽ⁱ⁺¹⁾=(F⁽ⁱ⁾+ΔF)mod M. F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, and M represents the total number of candidate frequency-domain resources in the deployment band corresponding to the AMP device.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=(F^{(r)}+ΔF)mod M. In the case where F^{(r+1)} is an available candidate frequency-domain resource for the AMP device, F⁽ⁱ⁺¹⁾=F^{(r+1)}. In the case where F^{(r+1)} is an unavailable candidate frequency-domain resource for the AMP device, r=r+11, and F^{(r+1)} is calculated based on updated r. F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, and M represents the total number of candidate frequency-domain resources in the deployment band corresponding to the AMP device.

In some embodiments, the candidate frequency-domain resource used by the AMP device in the (i+1)-th available time unit is determined based on the following formula: F⁽ⁱ⁺¹⁾=(F⁽ⁱ⁾+ΔF)mod(q+1)+p. F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, p represents the smallest number of the candidate frequency-domain resource in the deployment band corresponding to the AMP device, and q represents the largest number of the candidate frequency-domain resource in the deployment band corresponding to the AMP device. F⁽ⁱ⁾ satisfies p≤F⁽ⁱ⁾≤q, and F⁽ⁱ⁺¹⁾ satisfies p≤F⁽ⁱ⁺¹⁾≤q.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=(F^{(r)}+ΔF)mod(q+1)+p. In the case where F^{(r+1)} is an available candidate frequency-domain resource for the AMP device, F⁽ⁱ⁺¹⁾=F^{(r+1)}. In the case where F^{(r+1)} is an unavailable candidate frequency-domain resource for the AMP device, r=r+1, and F^{(r+1)} is calculated based on updated r. F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, p represents the smallest number of the candidate frequency-domain resource in the deployment band corresponding to the AMP device, and q represents the largest number of the candidate frequency-domain resource in the deployment band corresponding to the AMP device. F⁽ⁱ⁾ satisfies p≤F⁽ⁱ⁾≤q, and F⁽ⁱ⁺¹⁾ satisfies p≤F⁽ⁱ⁺¹⁾≤q.

In some embodiments, the candidate frequency-domain resource used by the AMP device in the (i+1)-th available time unit is determined based on the following formula: F⁽ⁱ⁺¹⁾=(F⁽ⁱ⁾+ΔF)mod(qₖ+1)+pₖ. F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device. F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=(F^{(r)}+ΔF)mod(qₖ+1)+pₖ. In the case where F^{(r+1)} is an available candidate frequency-domain resource for the AMP device, F⁽ⁱ⁺¹⁾=F^{(r+1)}. In the case where F^{(r+1)} is an unavailable candidate frequency-domain resource for the AMP device, r=r+1, and F^{(r+1)} is calculated based on updated r. F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device. F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ.

In some embodiments, the candidate frequency-domain resource used by the AMP device in the (i+1)-th available time unit is determined based on the following formula: F⁽ⁱ⁺¹⁾=F⁽ⁱ⁾+(−1)^{init}*(−1)^{S}ΔF. F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, a value of init is 0 or 1, and ΔF represents the hop interval. An initial value of S is 0, S=S+1 and F⁽ⁱ⁺¹⁾ is calculated based on updated S in the case where F⁽ⁱ⁾+(−1)^{init}*(−1)^{S}ΔF<p or F⁽ⁱ⁾+(−1)^{init}*(−1)^{S}ΔF>q, p represents the smallest number of the candidate frequency-domain resource in the deployment band corresponding to the AMP device, and q represents the largest number of the candidate frequency-domain resource in the deployment band corresponding to the AMP device; F⁽ⁱ⁾ satisfies p≤F⁽ⁱ⁾≤q, and F⁽ⁱ⁺¹⁾ satisfies p≤F⁽ⁱ⁺¹⁾≤q.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=F^{(r)}+(−1)^{init}*(−1)^{S}ΔF. In the case where F^{(r+1)} is an available candidate frequency-domain resource for the AMP device, F⁽ⁱ⁺¹⁾=F^{(r+1)}. In the case where F^{(r+1)} is an unavailable candidate frequency-domain resource for the AMP device, r=r+1, and F^{(r+1)} is calculated based on updated r. F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, a value of init is 0 or 1, and ΔF represents the hop interval. An initial value of S is 0, S=S+1 and F⁽ⁱ⁺¹⁾ is calculated based on updated S in the case where F⁽ⁱ⁾+(−1)^{init}*(−1)^{S}ΔF<p or F⁽ⁱ⁾+(−1)^{init}*(−1)^{S}ΔF>q, p represents the smallest number of the candidate frequency-domain resource in the deployment band corresponding to the AMP device, and q represents the largest number of the candidate frequency-domain resource in the deployment band corresponding to the AMP device. F⁽ⁱ⁾ satisfies p≤F⁽ⁱ⁾≤q, and F⁽ⁱ⁺¹⁾ satisfies p≤F⁽ⁱ⁺¹⁾≤q.

In some embodiments, the candidate frequency-domain resource used by the AMP device in the (i+1)-th available time unit is determined based on the following formula: F⁽ⁱ⁺¹⁾=F⁽ⁱ⁾+(−1)^{init}*(−1)^{S}ΔF. F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, a value of init is 0 or 1, and ΔF represents the hop interval. In a candidate frequency-domain resource set k associated with the AMP device in the deployment band corresponding to the AMP device, an initial value of S is 0, S=S+1 and F⁽ⁱ⁺¹⁾ is calculated based on updated S in the case where F⁽ⁱ⁾+(−1)^{init}*(−1)^{S}ΔF<pₖ or F⁽ⁱ⁾+(−1)^{init}*(−1)^{S}ΔF>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device. F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=F^{(r)}+(−1)^{init}*(−1)^{S}ΔF. In the case where F^{(r+1)} is an available candidate frequency-domain resource for the AMP device, F⁽ⁱ⁺¹⁾=F^{(r+1)}. In the case where F^{(r+1)} is an unavailable candidate frequency-domain resource for the AMP device, r=r+1, and F^{(r+1)} is calculated based on updated r. F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, a value of init is 0 or 1, and ΔF represents the hop interval. In a candidate frequency-domain resource set k associated with the AMP device in the deployment band corresponding to the AMP device, an initial value of S is 0, S=S+1 and F⁽ⁱ⁺¹⁾ is calculated based on updated S in the case where F⁽ⁱ⁾+(−1)^{init}*(−1)^{S}ΔF<pₖ or F⁽ⁱ⁾+(−1)^{init}*(−1)^{S}ΔF>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device. F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ.

In some embodiments, in the case where the number of candidate frequency-domain resources for transmitting the reference signal by the AMP device in the same available time unit is multiple, the j-th candidate frequency-domain resource used by the AMP device in the (i+1)-th available time unit is determined based on at least one of: the j-th candidate frequency-domain resource used by the AMP device in the i-th available time unit, a hop interval associated with the j-th candidate frequency-domain resource, the total number of candidate frequency-domain resources in a deployment band corresponding to the AMP device, a smallest number of a candidate frequency-domain resource in the deployment band corresponding to the AMP device, or a largest number of a candidate frequency-domain resource in the deployment band corresponding to the AMP device. j is a positive integer.

In some embodiments, the hop interval associated with the j-th candidate frequency-domain resource is a fixed value, or the hop interval associated with the j-th candidate frequency-domain resource is selected by looping in a second order from multiple preset hop intervals, or the hop interval associated with the j-th candidate frequency-domain resource is determined from the multiple preset hop intervals based on a value of i, or the hop interval associated with the j-th candidate frequency-domain resource is determined from the multiple preset hop intervals based on a value of a number of the j-th candidate frequency-domain resource used in the i-th available time unit.

In some embodiments, the j-th candidate frequency-domain resource used by the AMP device in the (i+1)-th available time unit is determined based on the following formula: F^{(i+1)_j}=(F^{(i)_j}+ΔF′)mod M. F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, and M represents the total number of candidate frequency-domain resources in the deployment band corresponding to the AMP device.

In some embodiments, the j-th candidate frequency-domain resource used by the AMP device in the (i+1)-th available time unit is determined based on the following formula: F^{(i+1)_j}=(F^{(i)_j}+ΔF′)mod(q+1)+p. F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, p represents the smallest number of the candidate frequency-domain resource in the deployment band corresponding to the AMP device, and q represents the largest number of the candidate frequency-domain resource in the deployment band corresponding to the AMP device. F^{(i)_j} satisfies p≤F^{(i)_j}≤q, and F^{(i+1)_j} satisfies p≤F^{(i+1)_j}≤q.

In some embodiments, the j-th candidate frequency-domain resource used by the AMP device in the (i+1)-th available time unit is determined based on the following formula: F^{(i+1)_j}=(F^{(i)_j}+ΔF′)mod(qₖ+1)+pₖ. F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device. F^{(i)_j} satisfies pₖ≤F^{(i)_j}≤qₖ, and F^{(i+1)_j} satisfies pₖ≤F^{(i+1)_j}≤qₖ.

In some embodiments, the j-th candidate frequency-domain resource used by the AMP device in the (i+1)-th available time unit is determined based on the following formula: F^{(i+1)_j}=F^{(i)_j}+(−1)^{init}*(−1)^{S}ΔF′. F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, a value of init is 0 or 1, and ΔF′ represents the hop interval associated with the j-th candidate frequency-domain resource. An initial value of S is 0, S=S+1 and F^{(i+1)_j} is calculated based on updated S in the case where F^{(i)_j}+(−1)^{init}*(−1)^{S}ΔF′<p or F^{(i)_j}+(−1)^{init}*(−1)^{S}ΔF′>q, p represents the smallest number of the candidate frequency-domain resource in the deployment band corresponding to the AMP device, and q represents the largest number of the candidate frequency-domain resource in the deployment band corresponding to the AMP device. F^{(i)_j} satisfies p≤F^{(i)_j}≤q, and F^{(i+1)_j} satisfies p≤F^{(i+1)_j}≤q.

In some embodiments, the j-th candidate frequency-domain resource used by the AMP device in the (i+1)-th available time unit is determined based on the following formula: F^{(i+1)_j}=F^{(i)_j}+(−1)^{init}*(−1)^{S}ΔF′. F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, a value of init is 0 or 1, and ΔF′ represents the hop interval associated with the j-th candidate frequency-domain resource. In a candidate frequency-domain resource set k associated with the AMP device in the deployment band corresponding to the AMP device, an initial value of S is 0, S=S+1 and F^{(i+1)_j} is calculated based on updated S in the case where F^{(i)_j}+(−1)^{init}*(−1)^{S}ΔF′<pₖ or F^{(i)_j}+(−1)^{init}*(−1)^{S}ΔF′>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device. F^{(i)_j} satisfies pₖ≤F^{(i)_j}≤qₖ, and F^{(i+1)_j}≤qₖ.

In some embodiments, the multiple candidate frequency-domain resources for transmitting the reference signal by the AMP device in the same available time unit are continuous, or the multiple candidate frequency-domain resources for transmitting the reference signal by the AMP device in the same available time unit are discontinuous.

In some embodiments, in the case where the number of candidate frequency-domain resources for transmitting the reference signal by the AMP device in the same available time unit is one, an available candidate frequency-domain resource used by the AMP device in the (i+1)-th available time unit is determined based on at least one of: an available candidate frequency-domain resource used by the AMP device in the i-th available time unit, a hop interval, the total number of available candidate frequency-domain resources for the AMP device in a deployment band corresponding to the AMP device, a smallest relative number of an available candidate frequency-domain resource for the AMP device in the deployment band corresponding to the AMP device, or a largest relative number of an available candidate frequency-domain resource for the AMP device in the deployment band corresponding to the AMP device.

In some embodiments, the hop interval is a fixed value, or the hop interval is selected by looping in a first order from multiple preset hop intervals, or the hop interval is determined from the multiple preset hop intervals based on a value of i, or the hop interval is determined from the multiple preset hop intervals based on a value of a relative number of the available candidate frequency-domain resource used in the i-th available time unit.

In some embodiments, the available candidate frequency-domain resource used by the AMP device in the (i+1)-th available time unit is determined based on the following formula: F⁽ⁱ⁺¹⁾=(F⁽ⁱ⁾+ΔF)mod M′. F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, ΔF represents the hop interval, and M′ represents the total number of available candidate frequency-domain resources for the AMP device in the deployment band corresponding to the AMP device.

In some embodiments, the available candidate frequency-domain resource used by the AMP device in the (i+1)-th available time unit is determined based on the following formula: F⁽ⁱ⁺¹⁾=(F⁽ⁱ⁾+ΔF)mod(q′+1)+p′. F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, ΔF represents the hop interval, p′ represents the smallest relative number of the available candidate frequency-domain resource for the AMP device in the deployment band corresponding to the AMP device, and q′ represents the largest relative number of the available candidate frequency-domain resource for the AMP device in the deployment band corresponding to the AMP device. F⁽ⁱ⁾ satisfies p′≤F⁽ⁱ⁾≤q′, and F⁽ⁱ⁺¹⁾ satisfies p′≤F⁽ⁱ⁺¹⁾≤q′.

In some embodiments, the available candidate frequency-domain resource used by the AMP device in the (i+1)-th available time unit is determined based on the following formula: F⁽ⁱ⁺¹⁾=(F⁽ⁱ⁾+ΔF)mod(qₖ′+1)+pₖ′. F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, ΔF represents the hop interval, pₖ′ represents a smallest relative number of an available candidate frequency-domain resource in a candidate frequency-domain resource set k associated with the AMP device in the deployment band corresponding to the AMP device, and qₖ′ represents a largest relative number of an available candidate frequency-domain resource in the candidate frequency-domain resource set k associated with the AMP device in the deployment band corresponding to the AMP device. F⁽ⁱ⁾ satisfies pₖ′≤F⁽ⁱ⁾≤qₖ′, and F⁽ⁱ⁺¹⁾ satisfies pₖ′≤F⁽ⁱ⁺¹⁾≤qₖ′.

In some embodiments, the available candidate frequency-domain resource used by the AMP device in the (i+1)-th available time unit is determined based on the following formula: F⁽ⁱ⁺¹⁾=F⁽ⁱ⁾+(−1)^{init}*(−1)^{S}ΔF. F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, a value of init is 0 or 1, and ΔF represents the hop interval. An initial value of S is 0, S=S+1 and F⁽ⁱ⁺¹⁾ is calculated based on updated S in the case where F⁽ⁱ⁾+(−1)^{init}*(−1)^{S}ΔF<p′ or F⁽ⁱ⁾+(−1)^{init}*(−1)^{S}ΔF>q′, p′ represents the smallest relative number of the available candidate frequency-domain resource for the AMP device in the deployment band corresponding to the AMP device, and q′ represents the largest relative number of the available candidate frequency-domain resource for the AMP device in the deployment band corresponding to the AMP device. F⁽ⁱ⁾ satisfies p′≤F⁽ⁱ⁾≤q′, and F⁽ⁱ⁺¹⁾ satisfies p′≤F⁽ⁱ⁺¹⁾≤q′.

In some embodiments, the available candidate frequency-domain resource used by the AMP device in the (i+1)-th available time unit is determined based on the following formula: F⁽ⁱ⁺¹⁾=F⁽ⁱ⁾+(−1)^{init}*(−1)^{S}ΔF. F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the

AMP device in the i-th available time unit, a value of init is 0 or 1, and ΔF represents the hop interval. In a candidate frequency-domain resource set k associated with the AMP device in the deployment band corresponding to the AMP device, an initial value of S is 0, S=S+1 and F⁽ⁱ⁺¹⁾ is calculated based on updated S in the case where F⁽ⁱ⁾+(−1)^{init}*(−1)^{S}ΔF<pₖ′ or F⁽ⁱ⁾+(−1)^{init}*(−1)^{S}ΔF>qₖ′, pₖ′ represents a smallest relative number of an available candidate frequency-domain resource in the candidate frequency-domain resource set k associated with the AMP device, and qₖ′ represents a largest relative number of an available candidate frequency-domain resource in the candidate frequency-domain resource set k associated with the AMP device. F⁽ⁱ⁾ satisfies pₖ′≤F⁽ⁱ⁾≤qₖ′, and F⁽ⁱ⁺¹⁾ satisfies pₖ′≤F⁽ⁱ⁺¹⁾≤qₖ′.

In some embodiments, an available candidate frequency-domain resource for the AMP device in the deployment band corresponding to the AMP device is configured by a network, or the available candidate frequency-domain resource for the AMP device in the deployment band corresponding to the AMP device is preempted and shared with the AMP device by a network device, or the available candidate frequency-domain resource for the AMP device in the deployment band corresponding to the AMP device is preempted by the AMP device.

In some embodiments, the value of init is randomly determined by the AMP device, or the value of init is configured by a network, or the value of init is determined based on a position of the first candidate frequency-domain resource initially selected, or the value of init is determined based on an identifier of the AMP device and/or an identifier of the receiver.

In some embodiments, the AMP device 300 further includes a processing unit 320. The processing unit 320 is configured to select the hop interval from multiple preset hop intervals based on a preset order, in the case where S=S+1 and the multiple preset hop intervals exist.

In some embodiments, the candidate frequency-domain resource set k associated with the AMP device is a candidate frequency-domain resource set configured or indicated by a network among multiple candidate frequency-domain resource sets in the deployment band corresponding to the AMP device. Alternatively, the candidate frequency-domain resource set k associated with the AMP device is determined from the multiple candidate frequency-domain resource sets in the deployment band corresponding to the AMP device based on an identifier of the AMP device and/or an identifier of a group to which the AMP device belongs. Alternatively, the candidate frequency-domain resource set k associated with the AMP device is determined from the multiple candidate frequency-domain resource sets in the deployment band corresponding to the AMP device based on a number of the first candidate frequency-domain resource initially selected by the AMP device.

In some embodiments, the multiple preset hop intervals have positive values and/or negative values.

In some embodiments, the first candidate frequency-domain resource initially selected by the AMP device is randomly selected, or the first candidate frequency-domain resource initially selected by the AMP device is configured by a network, or the first candidate frequency-domain resource initially selected by the AMP device is determined based on an identifier of the AMP device and/or an identifier of a peer device.

In some embodiments, the N candidate frequency-domain resources are determined based on at least one hopping pattern.

In some embodiments, the at least one hopping pattern is predefined by a protocol, or the at least one hopping pattern is configured by a network.

In some embodiments, a time unit is one of a symbol, a slot, a mini slot, a subframe, a second, a millisecond, and a microsecond.

In some embodiments, the N candidate frequency-domain resources are part or all of candidate frequency-domain resources in a deployment band corresponding to the AMP device; and/or, in the case where the AMP device transmits the reference signal over the N candidate frequency-domain resources, the AMP device transmits the reference signal over all or part of resources in each candidate frequency-domain resource among the N candidate frequency-domain resources; and/or, the N candidate frequency-domain resources do not overlap, or part of the N candidate frequency-domain resources overlap.

In some embodiments, the reference signal transmitted by the AMP device contains a frame header or a packet header, or the AMP device transmits information carrying the frame header or the packet header before transmitting the reference signal. The frame header or the packet header carries at least information of a time length in which a candidate frequency-domain resource is occupied.

In some embodiments, the frame header or the packet header further carries at least one of: information for identifying the AMP device; information for identifying the receiver; a synchronization/pilot sequence for obtaining synchronization information by the receiver; or configuration information of the reference signal transmitted by the AMP device.

In some embodiments, the AMP device transmits the reference signal on the N candidate frequency-domain resources as follows. The AMP device transmits the reference signal on the N candidate frequency-domain resources in a manner of active transmission or backscattering.

In some embodiments, the candidate frequency-domain resource is one of: a channel, a system bandwidth, a carrier bandwidth, a BWP, an aggregation/grouping/bundling of multiple BWPs, an aggregation/grouping/bundling of multiple subcarriers, and an aggregation/grouping/bundling of multiple PRBs.

In some embodiments, the number W of transmissions of the reference signal by the AMP device, a duration 77 for a single transmission of the reference signal by the AMP device, and time T during which the AMP device is scheduled by a network for communication have the following association relationship: W*T₁≤T. W is a positive integer, and both T and T₁ are positive numbers.

In some embodiments, the number of transmissions of the reference signal by the AMP device is predefined by a protocol, or the number of transmissions of the reference signal by the AMP device is configured by a network; and/or, a duration for a single transmission of the reference signal by the AMP device is predefined by a protocol, or the duration for a single transmission of the reference signal by the AMP device is configured by a network; and/or, a time interval between each two adjacent frequency-hopping transmissions of the reference signal by the AMP device is predefined by a protocol, or the time interval between each two adjacent frequency-hopping transmissions of the reference signal by the AMP device is configured by a network; and/or, a maximum duration for transmission of the reference signal by the AMP device is predefined by a protocol, or the maximum duration for transmission of the reference signal by the AMP device is configured by a network.

In some embodiments, different AMP devices use the same manner to determine candidate frequency-domain resources for transmitting reference signals for ranging and/or positioning based on a dual-frequency phase difference. Alternatively, different AMP devices use different manners to determine candidate frequency-domain resources for transmitting reference signals for ranging and/or positioning based on a dual-frequency phase difference.

In some embodiments, different AMP devices transmit reference signals for ranging and/or positioning based on a dual-frequency phase difference in a manner of FDM.

In some embodiments, the communication unit above may be a communication interface or a transceiver, or may be an input/output interface of a communication chip or an SOC. The processing unit above may be one or more processors.

It may be understood that, the AMP device 300 according to embodiments of the disclosure may correspond to the AMP device in the method embodiments of the disclosure, and the foregoing and other operations and/or functions of various units in the AMP device 300 are respectively intended for implementing corresponding procedures of the AMP device in the method 200 illustrated in FIG. 7, which will not be repeated herein for the sake of simplicity.

FIG. 18 is a schematic block diagram of a communication device 400 according to embodiments of the disclosure. As illustrated in FIG. 18, the communication device 400 includes a communication unit 410. The communication unit 410 is configured to receive a reference signal transmitted by an AMP device on N candidate frequency-domain resources. The reference signal transmitted on the N candidate frequency-domain resources is used to determine a position of the AMP device or a position of the communication device, and/or the reference signal transmitted on the N candidate frequency-domain resources is used to determine a distance between the AMP device and the communication device. N is a positive integer and N≥2.

In some embodiments, the number of candidate frequency-domain resources for transmitting the reference signal by the AMP device in the same available time unit is one or more.

In some embodiments, a candidate frequency-domain resource for transmitting the reference signal in the i-th available time unit is different from a candidate frequency-domain resource for transmitting the reference signal in the (i+1)-th available time unit, where i is an integer greater than or equal to 0.

In some embodiments, an interval between a candidate frequency-domain resource for transmitting the reference signal in the i-th available time unit and a candidate frequency-domain resource for transmitting the reference signal in the (i+1)-th available time unit is greater than or equal to X frequency-domain units, where X is a positive integer.

In some embodiments, the frequency-domain unit is one of: a candidate frequency-domain resource, a channel, a system bandwidth, a carrier, a subcarrier, a PRB, a BWP, a MHz, a kHz, and a Hz.

In some embodiments, in the case where the number of candidate frequency-domain resources for transmitting the reference signal by the AMP device in the same available time unit is one, a candidate frequency-domain resource used by the AMP device in the (i+1)-th available time unit is determined based on at least one of: a candidate frequency-domain resource used by the AMP device in the i-th available time unit, a hop interval, the total number of candidate frequency-domain resources in a deployment band corresponding to the AMP device, a smallest number of a candidate frequency-domain resource in the deployment band corresponding to the AMP device, or a largest number of a candidate frequency-domain resource in the deployment band corresponding to the AMP device.

In some embodiments, the hop interval is a fixed value, or the hop interval is selected by looping in a first order from multiple preset hop intervals, or the hop interval is determined from the multiple preset hop intervals based on a value of i, or the hop interval is determined from the multiple preset hop intervals based on a value of a number of a frequency-domain resource used in the i-th available time unit.

In some embodiments, the candidate frequency-domain resource used by the AMP device in the (i+1)-th available time unit is determined based on the following formula: F⁽ⁱ⁺¹⁾=(F⁽ⁱ⁾+ΔF)mod M. F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, and M represents the total number of candidate frequency-domain resources in the deployment band corresponding to the AMP device.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=(F^{(r)}+ΔF)mod M. In the case where F^{(r+1)} is an available candidate frequency-domain resource for the AMP device, F⁽ⁱ⁺¹⁾=F^{(r+1)}. In the case where F^{(r+1)} is an unavailable candidate frequency-domain resource for the AMP device, r=r+1, and F^{(r+1)} is calculated based on updated r. F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, and M represents the total number of candidate frequency-domain resources in the deployment band corresponding to the AMP device.

In some embodiments, the candidate frequency-domain resource used by the AMP device in the (i+1)-th available time unit is determined based on the following formula: F⁽ⁱ⁺¹⁾=(F⁽ⁱ⁾+ΔF)mod(q+1)+p. F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, p represents the smallest number of the candidate frequency-domain resource in the deployment band corresponding to the AMP device, and q represents the largest number of the candidate frequency-domain resource in the deployment band corresponding to the AMP device. F⁽ⁱ⁾ satisfies p≤F⁽ⁱ⁾≤q, and F⁽ⁱ⁺¹⁾ satisfies p≤F⁽ⁱ⁺¹⁾≤q.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=(F^{(r)}+ΔF)mod(q+1)+p. In the case where F^{(r+1)} is an available candidate frequency-domain resource for the AMP device, F⁽ⁱ⁺¹⁾=F^{(r+1)}. In the case where F^{(r+1)} is an unavailable candidate frequency-domain resource for the AMP device, r=r+1, and F^{(r+1)} is calculated based on updated r. F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF′ represents the hop interval, p represents the smallest number of the candidate frequency-domain resource in the deployment band corresponding to the AMP device, and q represents the largest number of the candidate frequency-domain resource in the deployment band corresponding to the AMP device. F⁽ⁱ⁾ satisfies p≤F⁽ⁱ⁾≤q, and F⁽ⁱ⁺¹⁾ satisfies p≤F⁽ⁱ⁺¹⁾≤q.

In some embodiments, the candidate frequency-domain resource used by the AMP device in the (i+1)-th available time unit is determined based on the following formula: F⁽ⁱ⁺¹⁾=(F⁽ⁱ⁾+ΔF)mod(qₖ+1)+pₖ. F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device. F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=(F^{(r)}+ΔF)mod(qₖ+1)+pₖ. In the case where F^{(r+1)} is an available candidate frequency-domain resource for the AMP device, F⁽ⁱ⁺¹⁾=F^{(r+1)}. In the case where F^{(r+1)} is an unavailable candidate frequency-domain resource for the AMP device, r=r+1, and F^{(r+1)} is calculated based on updated r. F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device. F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ.

In some embodiments, the candidate frequency-domain resource used by the AMP device in the (i+1)-th available time unit is determined based on the following formula: F⁽ⁱ⁺¹⁾=F⁽ⁱ⁾+(−1)^{init}*(−1)^{S}ΔF. F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, a value of init is 0 or 1, and ΔF represents the hop interval. An initial value of S is 0, S=S+1 and F⁽ⁱ⁺¹⁾ is calculated based on updated S in the case where F⁽ⁱ⁾+(−1)^{init}*(−1)^{S}ΔF<p or F⁽ⁱ⁾+(−1)^{init}*(−1)^{S}ΔF>q, p represents the smallest number of the candidate frequency-domain resource in the deployment band corresponding to the AMP device, and q represents the largest number of the candidate frequency-domain resource in the deployment band corresponding to the AMP device; F⁽ⁱ⁾ satisfies p≤F⁽ⁱ⁾≤q, and F⁽ⁱ⁺¹⁾ satisfies p≤F⁽ⁱ⁺¹⁾≤q.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=F^{(r)}+(−1)^{init}*(−1)^{S}ΔF. In the case where F^{(r+1)} is an available candidate frequency-domain resource for the AMP device, F⁽ⁱ⁺¹⁾=f^{(r+1)}. In the case where F^{(r+1)} is an unavailable candidate frequency-domain resource for the AMP device, r=r+1, and F^{(r+1)} is calculated based on updated r. F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, a value of init is 0 or 1, and ΔF represents the hop interval. An initial value of S is 0, S=S+1 and F⁽ⁱ⁺¹⁾ is calculated based on updated S in the case where F⁽ⁱ⁾+(−1)^{init}*(−1)^{S}ΔF<p or F⁽ⁱ⁾+(−1)^{init}*(−1)^{S}ΔF>q, p represents the smallest number of the candidate frequency-domain resource in the deployment band corresponding to the AMP device, and q represents the largest number of the candidate frequency-domain resource in the deployment band corresponding to the AMP device. F⁽ⁱ⁾ satisfies p≤F⁽ⁱ⁾≤q, and F⁽ⁱ⁺¹⁾ satisfies p≤F⁽ⁱ⁺¹⁾≤q.

In some embodiments, the candidate frequency-domain resource used by the AMP device in the (i+1)-th available time unit is determined based on the following formula: F⁽ⁱ⁺¹⁾=F⁽ⁱ⁾+(−1)^{init}*(−1)^{S}ΔF. F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, a value of init is 0 or 1, and ΔF represents the hop interval. In a candidate frequency-domain resource set k associated with the AMP device in the deployment band corresponding to the AMP device, an initial value of S is 0, S=S+1 and F⁽ⁱ⁺¹⁾ is calculated based on updated S in the case where F⁽ⁱ⁾+(−1)^{init}*(−1)^{S}ΔF<pₖ or F⁽ⁱ⁾+(−1)^{init}*(−1)^{S}ΔF>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device. F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ.

In some embodiments, in the case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=F^{(r)}+(−1)^{init}*(−1)^{S}ΔF. In the case where F^{(r+1)} is an available candidate frequency-domain resource for the AMP device, F⁽ⁱ⁺¹⁾=F^{(r+1)}. In the case where F^{(r+1)} is an unavailable candidate frequency-domain resource for the AMP device, r=r+1, and F^{(r+1)} is calculated based on updated r. F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, a value of init is 0 or 1, and ΔF represents the hop interval. In a candidate frequency-domain resource set k associated with the AMP device in the deployment band corresponding to the AMP device, an initial value of S is 0, S=S+1 and F⁽ⁱ⁺¹⁾ is calculated based on updated S in the case where F⁽ⁱ⁾+(−1)^{init}*(−1)^{S}ΔF<pₖ or F⁽ⁱ⁾+(−1)^{init}*(−1)^{S}ΔF>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device. F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ.

In some embodiments, in the case where the number of candidate frequency-domain resources for transmitting the reference signal by the AMP device in the same available time unit is multiple, the j-th candidate frequency-domain resource used by the AMP device in the (i+1)-th available time unit is determined based on at least one of: the j-th candidate frequency-domain resource used by the AMP device in the i-th available time unit, a hop interval associated with the j-th candidate frequency-domain resource, the total number of candidate frequency-domain resources in a deployment band corresponding to the AMP device, a smallest number of a candidate frequency-domain resource in the deployment band corresponding to the AMP device, or a largest number of a candidate frequency-domain resource in the deployment band corresponding to the AMP device. j is a positive integer.

In some embodiments, the hop interval associated with the j-th candidate frequency-domain resource is a fixed value, or the hop interval associated with the j-th candidate frequency-domain resource is selected by looping in a second order from multiple preset hop intervals, or the hop interval associated with the j-th candidate frequency-domain resource is determined from the multiple preset hop intervals based on a value of i, or the hop interval associated with the j-th candidate frequency-domain resource is determined from the multiple preset hop intervals based on a value of a number of the j-th candidate frequency-domain resource used in the i-th available time unit.

In some embodiments, the j-th candidate frequency-domain resource used by the AMP device in the (i+1)-th available time unit is determined based on the following formula: F^{(i+1)_j}=(F^{(i)_j}+ΔF′) mod M. F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, and M represents the total number of candidate frequency-domain resources in the deployment band corresponding to the AMP device.

In some embodiments, the j-th candidate frequency-domain resource used by the AMP device in the (i+1)-th available time unit is determined based on the following formula: F^{(i+1)_j}=(F^{(i)_j}+ΔF′) mod (q+1)+p. F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, p represents the smallest number of the candidate frequency-domain resource in the deployment band corresponding to the AMP device, and q represents the largest number of the candidate frequency-domain resource in the deployment band corresponding to the AMP device. F^{(i)_j} satisfies p≤F^{(i)_j}≤q, and F^{(i+1)_j} satisfies p≤F^{(i+1)_j}≤q.

In some embodiments, the j-th candidate frequency-domain resource used by the AMP device in the (i+1)-th available time unit is determined based on the following formula: F^{(i+1)_j}=(F^{(i)_j}+ΔF′) mod (qₖ+1)+pₖ. F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device. F^{(i)_j} satisfies pₖ≤F^{(i)_j}≤qₖ, and F^{(i+1)_j} satisfies pₖ≤F^{(i+1)_j}≤qₖ.

In some embodiments, the j-th candidate frequency-domain resource used by the AMP device in the (i+1)-th available time unit is determined based on the following formula: F^{(i+1)_j}=F^{(i)_j}+(−1)^{init}*(−1)^{S}ΔF′. F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, a value of init is 0 or 1, and ΔF′ represents the hop interval associated with the j-th candidate frequency-domain resource. An initial value of S is 0, S=S+1 and F^{(i+1)_j} is calculated based on updated S in the case where F^{(i)_j}+(−1)^{init}*(−1)^{S}ΔF′<p or F^{(i)_j}+(−1)^{init}*(−1)^{S}ΔF′>q, p represents the smallest number of the candidate frequency-domain resource in the deployment band corresponding to the AMP device, and q represents the largest number of the candidate frequency-domain resource in the deployment band corresponding to the AMP device. F^{(i)_j} satisfies p≤F^{(i)_j}≤q, and F^{(i+1)_j} satisfies p≤F^{(i+1)_j}≤q.

In some embodiments, the j-th candidate frequency-domain resource used by the AMP device in the (i+1)-th available time unit is determined based on the following formula: F^{(i+1)_j}=F^{(i)_j}+(−1)^{init}*(−1)^{S}ΔF′. F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, a value of init is 0 or 1, and ΔF′ represents the hop interval associated with the j-th candidate frequency-domain resource. In a candidate frequency-domain resource set k associated with the AMP device in the deployment band corresponding to the AMP device, an initial value of S is 0, S=S+1 and F^{(i+1)_j} is calculated based on updated S in the case where F^{(i)_j}+(−1)^{init}*(−1)^{S}ΔF′<pₖ or f^{(i)_j}+(−1)^{init}*(−1)^{S}ΔF′>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device. F^{(i)_j} satisfies pₖ≤F^{(i)_j}≤qₖ, and F^{(i+1)_j} satisfies pₖ≤F^{(i+1)_j}≤qₖ.

In some embodiments, the multiple candidate frequency-domain resources for transmitting the reference signal by the AMP device in the same available time unit are continuous, or the multiple candidate frequency-domain resources for transmitting the reference signal by the AMP device in the same available time unit are discontinuous.

In some embodiments, in the case where the number of candidate frequency-domain resources for transmitting the reference signal by the AMP device in the same available time unit is one, an available candidate frequency-domain resource used by the AMP device in the (i+1)-th available time unit is determined based on at least one of: an available candidate frequency-domain resource used by the AMP device in the i-th available time unit, a hop interval, the total number of available candidate frequency-domain resources for the AMP device in a deployment band corresponding to the AMP device, a smallest relative number of an available candidate frequency-domain resource for the AMP device in the deployment band corresponding to the AMP device, or a largest relative number of an available candidate frequency-domain resource for the AMP device in the deployment band corresponding to the AMP device.

In some embodiments, the hop interval is a fixed value, or the hop interval is selected by looping in a first order from multiple preset hop intervals, or the hop interval is determined from the multiple preset hop intervals based on a value of i, or the hop interval is determined from the multiple preset hop intervals based on a value of a relative number of the available candidate frequency-domain resource used in the i-th available time unit.

In some embodiments, the available candidate frequency-domain resource used by the AMP device in the (i+1)-th available time unit is determined based on the following formula: F⁽ⁱ⁺¹⁾=(F⁽ⁱ⁾+ΔF)mod M′. F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, ΔF represents the hop interval, and M′ represents the total number of available candidate frequency-domain resources for the AMP device in the deployment band corresponding to the AMP device.

In some embodiments, the available candidate frequency-domain resource used by the AMP device in the (i+1)-th available time unit is determined based on the following formula: F⁽ⁱ⁺¹⁾=(F⁽ⁱ⁾+ΔF) mod (q′+1)+p′. F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, ΔF represents the hop interval, p′ represents the smallest relative number of the available candidate frequency-domain resource for the AMP device in the deployment band corresponding to the AMP device, and q′ represents the largest relative number of the available candidate frequency-domain resource for the AMP device in the deployment band corresponding to the AMP device. F⁽ⁱ⁾ satisfies p′≤F⁽ⁱ⁾≤q′, and F⁽ⁱ⁺¹⁾ satisfies p′≤F⁽ⁱ⁺¹⁾≤q′.

In some embodiments, the available candidate frequency-domain resource used by the AMP device in the (i+1)-th available time unit is determined based on the following formula: F⁽ⁱ⁺¹⁾=(F⁽ⁱ⁾+ΔF) mod (qₖ′+1)+pₖ′. F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, ΔF represents the hop interval, pₖ′ represents a smallest relative number of an available candidate frequency-domain resource in a candidate frequency-domain resource set k associated with the AMP device in the deployment band corresponding to the AMP device, and qₖ′ represents a largest relative number of an available candidate frequency-domain resource in the candidate frequency-domain resource set k associated with the AMP device in the deployment band corresponding to the AMP device. F⁽ⁱ⁾ satisfies pₖ′≤F⁽ⁱ⁾≤qₖ′, and F⁽ⁱ⁺¹⁾ satisfies pₖ′≤F⁽ⁱ⁺¹⁾≤qₖ′.

In some embodiments, the available candidate frequency-domain resource used by the AMP device in the (i+1)-th available time unit is determined based on the following formula: F⁽ⁱ⁺¹⁾=F⁽ⁱ⁾+(−1)^{init}*(−1)^{S}ΔF. F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, a value of init is 0 or 1, and ΔF represents the hop interval. An initial value of S is 0, S=S+1 and F⁽ⁱ⁺¹⁾ is calculated based on updated S in the case where F⁽ⁱ⁾+(−1)^{init}*(−1)^{S}ΔF<p′ or F⁽ⁱ⁾+(−1)^{init}*(−1)^{S}ΔF>q′, p′represents the smallest relative number of the available candidate frequency-domain resource for the AMP device in the deployment band corresponding to the AMP device, and q′ represents the largest relative number of the available candidate frequency-domain resource for the AMP device in the deployment band corresponding to the AMP device. F⁽ⁱ⁾ satisfies p′≤F⁽ⁱ⁾≤q′, and F⁽ⁱ⁺¹⁾ satisfies p′≤F⁽ⁱ⁺¹⁾≤q′.

In some embodiments, the available candidate frequency-domain resource used by the AMP device in the (i+1)-th available time unit is determined based on the following formula: F⁽ⁱ⁺¹⁾=F⁽ⁱ⁾+(−1)^{init}*(−1)^{S}ΔF. F⁽ⁱ⁺¹⁾ represents a relative number of the available candidate frequency-domain resource used by the AMP device in the (i+1)-th available time unit, F⁽ⁱ⁾ represents a relative number of the available candidate frequency-domain resource used by the AMP device in the i-th available time unit, a value of init is 0 or 1, and ΔF represents the hop interval. In a candidate frequency-domain resource set k associated with the AMP device in the deployment band corresponding to the AMP device, an initial value of S is 0, S=S+1 and F⁽ⁱ⁺¹⁾ is calculated based on updated S in the case where F⁽ⁱ⁾+(−1)^{init}*(−1)^{S}ΔF<pₖ′ or F⁽ⁱ⁾+(−1)^{init}*(−1)^{S}ΔF>qₖ′, pₖ′ represents a smallest relative number of an available candidate frequency-domain resource in the candidate frequency-domain resource set k associated with the AMP device, and qₖ′ represents a largest relative number of an available candidate frequency-domain resource in the candidate frequency-domain resource set k associated with the AMP device. F⁽ⁱ⁾ satisfies pₖ′≤F⁽ⁱ⁾≤qₖ′, and f⁽ⁱ⁺¹⁾ satisfies pₖ′≤F⁽ⁱ⁺¹⁾≤qₖ′.

In some embodiments, an available candidate frequency-domain resource for the AMP device in the deployment band corresponding to the AMP device is configured by a network, or the available candidate frequency-domain resource for the AMP device in the deployment band corresponding to the AMP device is preempted and shared with the AMP device by a network device, or the available candidate frequency-domain resource for the AMP device in the deployment band corresponding to the AMP device is preempted by the AMP device.

In some embodiments, the value of init is randomly determined by the AMP device, or the value of init is configured by a network, or the value of init is determined based on a position of the first candidate frequency-domain resource initially selected, or the value of init is determined based on an identifier of the AMP device and/or an identifier of the receiver.

In some embodiments, the hop interval used by the AMP device is selected from multiple preset hop intervals based on a preset order, in the case where S=S+1 and the multiple preset hop intervals exist.

In some embodiments, the candidate frequency-domain resource set k associated with the AMP device is a candidate frequency-domain resource set configured or indicated by a network among multiple candidate frequency-domain resource sets in the deployment band corresponding to the AMP device. Alternatively, the candidate frequency-domain resource set k associated with the AMP device is determined from the multiple candidate frequency-domain resource sets in the deployment band corresponding to the AMP device based on an identifier of the AMP device and/or an identifier of a group to which the AMP device belongs. Alternatively, the candidate frequency-domain resource set k associated with the AMP device is determined from the multiple candidate frequency-domain resource sets in the deployment band corresponding to the AMP device based on a number of the first candidate frequency-domain resource initially selected by the AMP device.

In some embodiments, the multiple preset hop intervals have positive values and/or negative values.

In some embodiments, the first candidate frequency-domain resource initially selected by the AMP device is randomly selected, or the first candidate frequency-domain resource initially selected by the AMP device is configured by a network, or the first candidate frequency-domain resource initially selected by the AMP device is determined based on an identifier of the AMP device and/or an identifier of a peer device.

In some embodiments, the N candidate frequency-domain resources are determined based on at least one hopping pattern.

In some embodiments, the at least one hopping pattern is predefined by a protocol, or the at least one hopping pattern is configured by a network.

In some embodiments, a time unit is one of a symbol, a slot, a mini slot, a subframe, a second, a millisecond, and a microsecond.

In some embodiments, the N candidate frequency-domain resources are part or all of candidate frequency-domain resources in a deployment band corresponding to the AMP device; and/or, in the case where the AMP device transmits the reference signal over the N candidate frequency-domain resources, the AMP device transmits the reference signal over all or part of resources in each candidate frequency-domain resource among the N candidate frequency-domain resources; and/or, the N candidate frequency-domain resources do not overlap, or part of the N candidate frequency-domain resources overlap.

In some embodiments, the reference signal transmitted by the AMP device contains a frame header or a packet header, or the AMP device transmits information carrying the frame header or the packet header before transmitting the reference signal. The frame header or the packet header carries at least information of a time length in which a candidate frequency-domain resource is occupied.

In some embodiments, the frame header or the packet header further carries at least one of: information for identifying the AMP device; information for identifying the receiver; a synchronization/pilot sequence for obtaining synchronization information by the receiver; or configuration information of the reference signal transmitted by the AMP device.

In some embodiments, the AMP device transmits the reference signal on the N candidate frequency-domain resources as follows. The AMP device transmits the reference signal on the N candidate frequency-domain resources in a manner of active transmission or backscattering.

In some embodiments, the candidate frequency-domain resource is one of: a channel, a system bandwidth, a carrier bandwidth, a BWP, an aggregation/grouping/bundling of multiple BWPs, an aggregation/grouping/bundling of multiple subcarriers, and an aggregation/grouping/bundling of multiple PRBs.

In some embodiments, the number W of transmissions of the reference signal by the AMP device, a duration T₁ for a single transmission of the reference signal by the AMP device, and time T during which the AMP device is scheduled by a network for communication have the following association relationship: W*T₁≤T. W is a positive integer, and both Tand Ty are positive numbers.

In some embodiments, the number of transmissions of the reference signal by the AMP device is predefined by a protocol, or the number of transmissions of the reference signal by the AMP device is configured by a network; and/or, a duration for a single transmission of the reference signal by the AMP device is predefined by a protocol, or the duration for a single transmission of the reference signal by the AMP device is configured by a network; and/or, a time interval between each two adjacent frequency-hopping transmissions of the reference signal by the AMP device is predefined by a protocol, or the time interval between each two adjacent frequency-hopping transmissions of the reference signal by the AMP device is configured by a network; and/or, a maximum duration for transmission of the reference signal by the AMP device is predefined by a protocol, or the maximum duration for transmission of the reference signal by the AMP device is configured by a network.

In some embodiments, different AMP devices use the same manner to determine candidate frequency-domain resources for transmitting reference signals for ranging and/or positioning based on a dual-frequency phase difference. Alternatively, different AMP devices use different manners to determine candidate frequency-domain resources for transmitting reference signals for ranging and/or positioning based on a dual-frequency phase difference.

In some embodiments, different AMP devices transmit reference signals for ranging and/or positioning based on a dual-frequency phase difference in a manner of FDM.

In some embodiments, the communication device is one of: an AP, an STA, a base station, a terminal device, and a TRP.

In some embodiments, the communication unit above may be a communication interface or a transceiver, or may be an input/output interface of a communication chip or an SOC. The processing unit above may be one or more processors.

It may be understood that, the communication device 400 according to embodiments of the disclosure may correspond to the communication device in the method embodiments of the disclosure, and the foregoing and other operations and/or functions of various units in the communication device 400 are respectively intended for implementing corresponding procedures of the communication device in the method 200 illustrated in FIG. 7, which will not be repeated herein for the sake of simplicity.

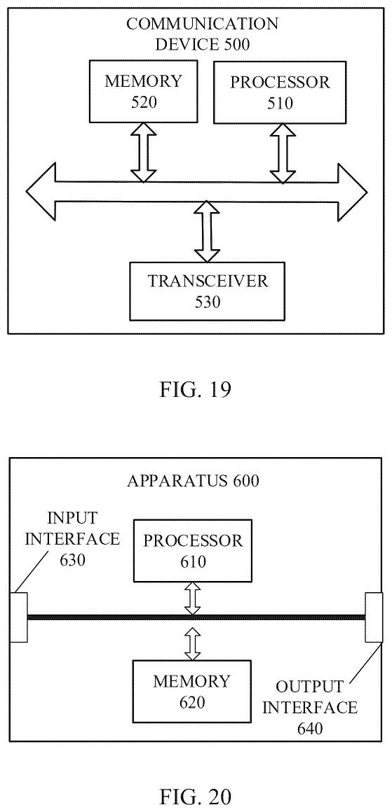

FIG. 19 is a schematic structural diagram of a communication device 500 provided in embodiments of the disclosure. The communication device 500 illustrated in FIG. 19 includes a processor 510. The processor 510 can invoke and execute a computer program stored in a memory, so as to implement the method in embodiments of the disclosure.

In some embodiments, as illustrated in FIG. 19, the communication device 500 may further include a memory 520. The processor 510 can invoke and execute a computer program stored in the memory 520, so as to implement the method in embodiments of the disclosure.

The memory 520 may be a separate device independent of the processor 510, or may be integrated into the processor 510.

In some embodiments, as illustrated in FIG. 19, the communication device 500 may further include a transceiver 530. The processor 510 can control the transceiver 530 to communicate with other devices, specifically, to transmit information or data to other devices or to receive information or data from other devices.

The transceiver 530 may include a transmitter and a receiver. The transceiver 530 may further include an antenna, where one or more antennas may be provided.

In some embodiments, the processor 510 may implement the function of a processing unit in the AMP device 300, or the processor 510 may implement the function of a processing unit in the communication device 400, which will not be repeated herein for the sake of simplicity.

In some embodiments, the transceiver 530 may implement the function of a communication unit in the AMP device 300, which will not be repeated herein for the sake of simplicity.

In some embodiments, the transceiver 530 may implement the function of a communication unit in the communication device 400, which will not be repeated herein for the sake of simplicity.

In some embodiments, the communication device 500 may specifically be the communication device 400 in embodiments of the disclosure, and the communication device 500 may implement corresponding operations implemented by the communication device 400 in various methods in embodiments of the disclosure, which will not be repeated herein for the sake of simplicity.

In some embodiments, the communication device 500 may specifically be the AMP device 300 in embodiments of the disclosure, and the communication device 500 may implement corresponding operations implemented by the AMP device 300 in various methods in embodiments of the disclosure, which will not be repeated herein for the sake of simplicity.

FIG. 20 is a schematic structural diagram of an apparatus according to embodiments of the disclosure. The apparatus 600 illustrated in FIG. 20 includes a processor 610. The processor 610 can invoke and execute a computer program stored in a memory, so as to implement the method in embodiments of the disclosure.

In some embodiments, as illustrated in FIG. 20, the apparatus 600 may further include a memory 620. The processor 610 can invoke and execute a computer program stored in the memory 620, so as to implement the method in embodiments of the disclosure.

The memory 620 may be a separate device independent of the processor 610, or may be integrated into the processor 610.

In some embodiments, the processor 610 may implement the function of a processing unit in the AMP device 300, or the processor 610 may implement the function of a processing unit in the communication device 400, which will not be repeated herein for the sake of simplicity.

In some embodiments, the apparatus 600 may further include an input interface 630. The processor 610 can control the input interface 630 to communicate with other devices or chips, and specifically, to obtain information or data transmitted by other devices or chips. Optionally, the processor 610 may be located in chip or off chip.

In some embodiments, the input interface 630 may implement the function of a communication unit in the AMP device 300, or the input interface 630 may implement the function of a communication unit in the communication device 400.

In some embodiments, the apparatus 600 may further include an output interface 640. The processor 610 can control the output interface 640 to communicate with other devices or chips, and specifically, to output information or data to other devices or chips. Optionally, the processor 610 may be located in chip or off chip.

In some embodiments, the output interface 640 may implement the function of the communication unit in the AMP device 300, or the output interface 640 may implement the function of the communication unit in the communication device 400.

In some embodiments, the apparatus may be applied to the communication device in embodiments of the disclosure, and the apparatus may implement corresponding operations implemented by the communication device in various methods in embodiments of the disclosure, which will not be repeated herein for the sake of simplicity.

In some embodiments, the apparatus may be applied to the AMP device in embodiments of the disclosure, and the apparatus may implement corresponding operations implemented by the AMP device in various methods in embodiments of the disclosure, which will not be repeated herein for the sake of simplicity.

In some embodiments, the apparatus mentioned in embodiments of the disclosure may also be a chip, for example, an SoC.

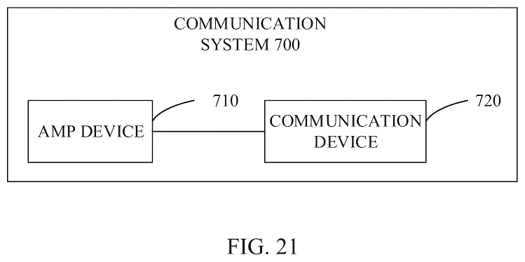

FIG. 21 is a schematic block diagram of a communication system 700 provided in embodiments of the disclosure. As illustrated in FIG. 21, the communication system 700 includes an AMP device 710 and a communication device 720.

The AMP device 710 may be configured to implement corresponding functions implemented by the AMP device in the foregoing methods, and the communication device 720 may be configured to implement corresponding functions implemented by the communication device in the foregoing methods, which will not be repeated herein for the sake of simplicity.

It may be understood that, the processor in embodiments of the disclosure may be an integrated circuit chip with signal processing capabilities. During implementation, each step of the foregoing method embodiments may be completed by an integrated logic circuit of hardware in the processor or an instruction in the form of software. The processor may be a general-purpose processor, a digital signal processor (DSP), an ASIC, a field programmable gate array (FPGA), or other programmable logic devices, discrete gates or transistor logic devices, discrete hardware components. The methods, steps, and logic blocks disclosed in embodiments of the disclosure can be implemented or executed. The general-purpose processor may be a microprocessor, or the processor may be any conventional processor or the like. The steps of the method disclosed in embodiments of the disclosure may be directly implemented by a hardware decoding processor, or may be performed by hardware and software modules in the decoding processor. The software module can be located in a storage medium mature in the skill such as a random access memory (RAM), a flash memory, a read-only memory (ROM), a programmable ROM (PROM), or an electrically erasable programmable memory, registers, and the like. The storage medium is located in the memory. The processor reads the information in the memory, and completes the steps of the method described above with the hardware of the processor.

It may be understood that, the memory in embodiments of the disclosure may be a volatile memory or a non-volatile memory, or may include both the volatile memory and the non-volatile memory. The non-volatile memory may be an ROM, a PROM, an erasable PROM (EPROM), an electrically EPROM (EEPROM), or a flash memory. The volatile memory may be an RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It may be noted that, the memory of the systems and methods described in the disclosure is intended to include, but is not limited to, these and any other suitable types of memory.

It may be understood that, the memory above is intended for illustration rather than limitation. For example, the memory in embodiments of the disclosure may also be an SRAM, a DRAM, an SDRAM, a DDR SDRAM, an ESDRAM, an SLDRAM, a DR RAM, etc. In other words, the memory in embodiments of the disclosure is intended to include, but is not limited to, these and any other suitable types of memory.

A computer-readable storage medium is further provided in embodiments of the disclosure. The computer-readable storage medium is configured to store a computer program.

In some embodiments, the computer-readable storage medium may be applied to the communication device in embodiments of the disclosure, and the computer program causes a computer to execute corresponding operations implemented by the communication device in various methods in embodiments of the disclosure, which will not be repeated herein for the sake of simplicity.

In some embodiments, the computer-readable storage medium may be applied to the AMP device in embodiments of the disclosure, and the computer program causes a computer to execute corresponding operations implemented by the AMP device in various methods in embodiments of the disclosure, which will not be repeated herein for the sake of simplicity.

A computer program product is further provided in embodiments of the disclosure. The computer program product includes computer program instructions.

In some embodiments, the computer program product may be applied to the communication device in embodiments of the disclosure, and the computer program instructions cause a computer to execute corresponding operations implemented by the communication device in various methods in embodiments of the disclosure, which will not be repeated herein for the sake of simplicity.

In some embodiments, the computer program product may be applied to the AMP device in embodiments of the disclosure, and the computer program instructions cause a computer to execute corresponding operations implemented by the AMP device in various methods in embodiments of the disclosure, which will not be repeated herein for the sake of simplicity.

A computer program is further provided in embodiments of the disclosure.

In some embodiments, the computer program may be applied to the communication device in embodiments of the disclosure. The computer program, when executed by a computer, causes the computer to implement corresponding operations implemented by the communication device in various methods in embodiments of the disclosure, which will not be repeated herein for the sake of simplicity.

In some embodiments, the computer program may be applied to the AMP device in embodiments of the disclosure. The computer program, when executed by a computer, causes the computer to implement corresponding operations implemented by the AMP device in various methods in embodiments of the disclosure, which will not be repeated herein for the sake of simplicity.

It will be appreciated by those of ordinary skill in the art that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be evident to those skilled in the art that, for the sake of convenience and simplicity, in terms of the specific working processes of the foregoing systems, apparatuses, and units, reference can be made to the corresponding processes in the foregoing method embodiments, which will not be repeated herein.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure.

In addition, various functional units described in various embodiments of the disclosure may be integrated into one processing unit or may be present as a number of physically separated units, and two or more units may be integrated into one.

If the functions are implemented as software functional units and sold or used as standalone products, they may be stored in a computer-readable storage medium. Based on such an understanding, the essential technical solution, or the portion that contributes to the prior art, or part of the technical solution of the disclosure may be embodied as software products. The computer software products can be stored in a storage medium and may include multiple instructions that, when executed, can cause a computer device, e.g., a personal computer, a server, a network device, etc., to execute some or all operations of the methods described in various embodiments of the disclosure. The above storage medium may include various kinds of media that can store program codes, such as a universal serial bus (USB) flash disk, a mobile hard drive, an ROM, an RAM, a magnetic disk, or an optical disk.

The foregoing elaborations are merely embodiments of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

What is claimed is:

1. A method for wireless communication, comprising:
transmitting, by an ambient power (AMP) device, a reference signal on N candidate frequency-domain resources;
wherein the reference signal transmitted on the N candidate frequency-domain resources is used to determine a position of the AMP device or a position of a receiver of the reference signal, and/or the reference signal transmitted on the N candidate frequency-domain resources is used to determine a distance between the AMP device and the receiver of the reference signal, wherein N is a positive integer and N≥2.

2. The method of claim 1, wherein a number of candidate frequency-domain resources for transmitting the reference signal by the AMP device in a same available time unit is one or more.

3. The method of claim 2, wherein:
in a case where a number of candidate frequency-domain resources for transmitting the reference signal by the AMP device in a same available time unit is one, a candidate frequency-domain resource used by the AMP device in an (i+1)-th available time unit is determined based on at least one of:
a candidate frequency-domain resource used by the AMP device in an i-th available time unit, a hop interval, a total number of candidate frequency-domain resources in a deployment band corresponding to the AMP device, a smallest number of a candidate frequency-domain resource in the deployment band corresponding to the AMP device, or a largest number of a candidate frequency-domain resource in the deployment band corresponding to the AMP device.

4. The method of claim 3, wherein:
the hop interval is a fixed value, or the hop interval is selected by looping in a first order from a plurality of preset hop intervals, or the hop interval is determined from the plurality of preset hop intervals based on a value of i, or the hop interval is determined from the plurality of preset hop intervals based on a value of a number of a frequency-domain resource used in the i-th available time unit.

5. The method of claim 3, wherein:
the candidate frequency-domain resource used by the AMP device in the (i+1)-th available time unit is determined based on the following formula: F⁽ⁱ⁺¹⁾=(F⁽ⁱ⁾+ΔF)mod M; wherein F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, and M represents the total number of candidate frequency-domain resources in the deployment band corresponding to the AMP device; or
in a case where F⁽ⁱ⁾ is an available candidate frequency-domain resource for the AMP device, F^{(r)}=F⁽ⁱ⁾ and an available candidate frequency-domain resource used by the AMP device in the (i+1)-th available time unit is determined based on the following formula: F^{(r+1)}=(F^{(r)}+ΔF)mod M; in a case where F^{(r+1)} is an available candidate frequency-domain resource for the AMP device, F⁽ⁱ⁺¹⁾=F^{(r+1)}; and in a case where F^{(r+1)} is an unavailable candidate frequency-domain resource for the AMP device, r=r+1, and F^{(r+1)} is calculated based on updated r; wherein F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, and M represents the total number of candidate frequency-domain resources in the deployment band corresponding to the AMP device; or
the candidate frequency-domain resource used by the AMP device in the (i+1)-th available time unit is determined based on the following formula: F⁽ⁱ⁺¹⁾=(F⁽ⁱ⁾+ΔF)mod(q+1)+p; wherein F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, p represents the smallest number of the candidate frequency-domain resource in the deployment band corresponding to the AMP device, and q represents the largest number of the candidate frequency-domain resource in the deployment band corresponding to the AMP device; wherein F⁽ⁱ⁾ satisfies p≤F⁽ⁱ⁾≤q, and F⁽ⁱ⁺¹⁾ satisfies p≤F⁽ⁱ⁺¹⁾≤q; or
in a case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=(F^{(r)}+ΔF)mod(q+1)+p; in a case where F^{(r+1)} is an available candidate frequency-domain resource for the AMP device, F⁽ⁱ⁺¹⁾=F^{(r+1)}; and in a case where F^{(r+1)} is an unavailable candidate frequency-domain resource for the AMP device, r=r+1, and F^{(r+1)} is calculated based on updated r; wherein F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, p represents the smallest number of the candidate frequency-domain resource in the deployment band corresponding to the AMP device, and q represents the largest number of the candidate frequency-domain resource in the deployment band corresponding to the AMP device; wherein F⁽ⁱ⁾ satisfies p≤F⁽ⁱ⁾≤q, and F⁽ⁱ⁺¹⁾ satisfies p≤F⁽ⁱ⁺¹⁾≤q; or
the candidate frequency-domain resource used by the AMP device in the (i+1)-th available time unit is determined based on the following formula: F⁽ⁱ⁺¹⁾=(F⁽ⁱ⁾+ΔF)mod(qₖ+1)+pₖ; wherein F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, ΔF represents the hop interval, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device; wherein F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ; or
in a case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=F^{(r)}+ΔF)mod(qₖ+1)+pₖ; in a case where F^{(r+1)} is an available candidate frequency-domain resource for the AMP device, F⁽ⁱ⁺¹⁾=F^{(r+1)}; and in a case where F^{(r+1)} is an unavailable candidate frequency-domain resource for the AMP device, r=r+1, and F^{(r+1)} is calculated based on updated r; wherein F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, ΔF represents the hop interval, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device; wherein F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ; or
the candidate frequency-domain resource used by the AMP device in the (i+1)-th available time unit is determined based on the following formula: F⁽ⁱ⁺¹⁾≤F⁽ⁱ⁾+(−1)^{init}*(−1)^{S}ΔF; wherein F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, a value of init is 0 or 1, and ΔF represents the hop interval; wherein an initial value of S is O, S=S+1 and F⁽ⁱ⁺¹⁾ is calculated based on updated S in a case where F⁽ⁱ⁾+(−1)^{init}*(−1)^{S}ΔF<p or F⁽ⁱ⁾+(−1)^{init}*(−1)^{S}ΔF>q, p represents the smallest number of the candidate frequency-domain resource in the deployment band corresponding to the AMP device, and q represents the largest number of the candidate frequency-domain resource in the deployment band corresponding to the AMP device; wherein F⁽ⁱ⁾ satisfies p≤F⁽ⁱ⁾≤q, and F⁽ⁱ⁺¹⁾ satisfies p≤F⁽ⁱ⁺¹⁾≤q; or
in a case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=F^{(r)}+(−1)^{init}*(−1)^{S}ΔF; in a case where F^{(r+1)} is an available candidate frequency-domain resource for the AMP device, F⁽ⁱ⁺¹⁾=F^{(r+1)}; and in a case where F^{(r+1)} is an unavailable candidate frequency-domain resource for the AMP device, r=r+1, and F^{(r+1)} is calculated based on updated r; wherein F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, a value of init is 0 or 1, and ΔF represents the hop interval; wherein an initial value of S is 0, S=S+1 and F⁽ⁱ⁺¹⁾ is calculated based on updated S in a case where F⁽ⁱ⁾+(−1)^{init}*(−1)^{S}ΔF<p or F⁽ⁱ⁾+(−1)^{init}*(−1)^{S}ΔF>q, p represents the smallest number of the candidate frequency-domain resource in the deployment band corresponding to the AMP device, and q represents the largest number of the candidate frequency-domain resource in the deployment band corresponding to the AMP device; wherein F⁽ⁱ⁾ satisfies p≤F⁽ⁱ⁾≤q, and F⁽ⁱ⁺¹⁾ satisfies p≤F⁽ⁱ⁺¹⁾≤q; or
the candidate frequency-domain resource used by the AMP device in the (i+1)-th available time unit is determined based on the following formula: F⁽ⁱ⁺¹⁾=F⁽ⁱ⁾+(−1)^{init}*(−1)^{S}ΔF; wherein F⁽ⁱ⁺¹⁾ represents a number of the candidate frequency-domain resource used by the AMP device in the (i+1)-th available time unit, F⁽ⁱ⁾ represents a number of the candidate frequency-domain resource used by the AMP device in the i-th available time unit, a value of init is 0 or 1, and ΔF represents the hop interval; wherein in a candidate frequency-domain resource set k associated with the AMP device in the deployment band corresponding to the AMP device, an initial value of S is 0, S=S+1 and F⁽ⁱ⁺¹⁾ is calculated based on updated S in a case where F⁽ⁱ⁾+(−1)^{init}*(−1)^{S}ΔF<pₖ or F⁽ⁱ⁾+(−1)^{init}*(−1)^{S}ΔF>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device; wherein F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ; or
in a case where F⁽ⁱ⁾ is an available candidate frequency-domain resource for the AMP device, F^{(r)}=F⁽ⁱ⁾, and an available candidate frequency-domain resource used by the AMP device in the (i+1)-th available time unit is determined based on the following formula: F^{(r+1)}=F^{(r)}+(−1)^{init}*(−1)^{S}ΔF; in a case where F^{(r+1)} is an available candidate frequency-domain resource for the AMP device, F⁽ⁱ⁺¹⁾=F^{(r+1)}; and in a case where F^{(r+1)} is an unavailable candidate frequency-domain resource for the AMP device, r=r+1, and F^{(r+1)} is calculated based on updated r; wherein F⁽ⁱ⁺¹⁾ represents a number of the available candidate frequency-domain resource used by the AMP device in the (i+1)-th available time unit, F⁽ⁱ⁾ represents a number of the available candidate frequency-domain resource used by the AMP device in the i-th available time unit, a value of init is 0 or 1, and ΔF represents the hop interval; wherein in a candidate frequency-domain resource set k associated with the AMP device in the deployment band corresponding to the AMP device, an initial value of S is 0, S=S+1 and F⁽ⁱ⁺¹⁾ is calculated based on updated S in a case where F⁽ⁱ⁾+(−1)^{init}*(−1)^{S}ΔF<pₖ or F⁽ⁱ⁾+(−1)^{init}*(−1)^{S}ΔF>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device; wherein F⁽ⁱ⁾ satisfies pₖ≤F⁽ⁱ⁾≤qₖ, and F⁽ⁱ⁺¹⁾ satisfies pₖ≤F⁽ⁱ⁺¹⁾≤qₖ.

6. The method of claim 2, wherein in a case where a number of candidate frequency-domain resources for transmitting the reference signal by the AMP device in a same available time unit is greater than one, a j-th candidate frequency-domain resource used by the AMP device in an (i+1)-th available time unit is determined based on at least one of:
a j-th candidate frequency-domain resource used by the AMP device in an i-th available time unit, a hop interval associated with a j-th candidate frequency-domain resource, a total number of candidate frequency-domain resources in a deployment band corresponding to the AMP device, a smallest number of a candidate frequency-domain resource in the deployment band corresponding to the AMP device, or a largest number of a candidate frequency-domain resource in the deployment band corresponding to the AMP device;
wherein j is a positive integer.

7. The method of claim 6, wherein the hop interval associated with the j-th candidate frequency-domain resource is a fixed value, or the hop interval associated with the j-th candidate frequency-domain resource is selected by looping in a second order from a plurality of preset hop intervals, or the hop interval associated with the j-th candidate frequency-domain resource is determined from the plurality of preset hop intervals based on a value of i, or the hop interval associated with the j-th candidate frequency-domain resource is determined from the plurality of preset hop intervals based on a value of a number of the j-th candidate frequency-domain resource used in the i-th available time unit.

8. The method of claim 6, wherein:
the j-th candidate frequency-domain resource used by the AMP device in the (i+1)-th available time unit is determined based on the following formula: F^{(i+1)_j}=(F^{(i)_j}+ΔF′)mod M; wherein F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, and M represents the total number of candidate frequency-domain resources in the deployment band corresponding to the AMP device; or
the j-th candidate frequency-domain resource used by the AMP device in the (i+1)-th available time unit is determined based on the following formula: F^{(i+1)_j}=(F^{(i)_j}+ΔF′)mod(q+1)+p; wherein F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF″ represents the hop interval associated with the j-th candidate frequency-domain resource, p represents the smallest number of the candidate frequency-domain resource in the deployment band corresponding to the AMP device, and q represents the largest number of the candidate frequency-domain resource in the deployment band corresponding to the AMP device; wherein F^{(i)_j} satisfies p≤F^{(i)_j}≤q, and F^{(i+1)_j} satisfies p≤F^{(i+1)_j}≤q; or
the j-th candidate frequency-domain resource used by the AMP device in the (i+1)-th available time unit is determined based on the following formula: F^{(i+1)_j}=(F^{(i)_j}+ΔF′)mod(qₖ+1)+pₖ; wherein F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, ΔF′ represents the hop interval associated with the j-th candidate frequency-domain resource, pₖ represents a smallest number of a candidate frequency-domain resource in a candidate frequency-domain resource set k associated with the AMP device in the deployment band corresponding to the AMP device, and qₖ represents a largest number of a candidate frequency-domain resource in the candidate frequency-domain resource set k associated with the AMP device in the deployment band corresponding to the AMP device; wherein F^{(i)_j} satisfies pₖ≤F^{(i)_j}≤qₖ, and F^{(i+1)_j} satisfies pₖ≤F^{(i+1)_j}≤qₖ; or
the j-th candidate frequency-domain resource used by the AMP device in the (i+1)-th available time unit is determined based on the following formula: F^{(i+1)_j}=F^{(i)_j}+(−1)^{init}*(−1)^{S}ΔF′; wherein F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, a value of init is 0 or 1, and ΔF′ represents the hop interval associated with the j-th candidate frequency-domain resource; wherein an initial value of S is 0, S=S+1 and F^{(i+1)_j} is calculated based on updated S in a case where F^{(i)_j}+(−1)^{init}*(−1)^{S}ΔF′<p or F^{(i)_j}+(−1)^{init}*(−1)^{S}ΔF′>q, p represents the smallest number of the candidate frequency-domain resource in the deployment band corresponding to the AMP device, and q represents the largest number of the candidate frequency-domain resource in the deployment band corresponding to the AMP device; wherein F^{(i)_j} satisfies p≤F^{(i)_j}≤q, and F^{(i+1)_j} satisfies p≤F^{(i+1)_j}≤q; or
the j-th candidate frequency-domain resource used by the AMP device in the (i+1)-th available time unit is determined based on the following formula: F^{(i+1)_j}=F^{(i)_j}+(−1)^{init}*(−1)^{S}ΔF′; wherein F^{(i+1)_j} represents a number of the j-th candidate frequency-domain resource used by the AMP device in the (i+1)-th available time unit, F^{(i)_j} represents a number of the j-th candidate frequency-domain resource used by the AMP device in the i-th available time unit, a value of init is 0 or 1, and ΔF′ represents the hop interval associated with the j-th candidate frequency-domain resource; wherein in a candidate frequency-domain resource set k associated with the AMP device in the deployment band corresponding to the AMP device, an initial value of S is 0, S=S+1 and F^{(i+1)_j} is calculated based on updated S in a case where F^{(i)_j}+(−1)^{init}*(−1)^{S}ΔF′<pₖ or F^{(i)_j}+(−1)^{init}*(−1)^{S}ΔF′>qₖ, pₖ represents a smallest number of a candidate frequency-domain resource in the candidate frequency-domain resource set k associated with the AMP device, and qₖ represents a largest number of a candidate frequency-domain resource in the candidate frequency-domain resource set k associated with the AMP device; wherein F^{(i)_j} satisfies pₖ≤F^{(i)_j}≤qₖ, and F^{(i+1)_j} satisfies pₖ≤F^{(i+1)_j}≤qₖ.

9. The method of claim 6, wherein the plurality of candidate frequency-domain resources for transmitting the reference signal by the AMP device in the same available time unit are continuous, or the plurality of candidate frequency-domain resources for transmitting the reference signal by the AMP device in the same available time unit are discontinuous.

10. The method of claim 2, wherein in a case where a number of candidate frequency-domain resources for transmitting the reference signal by the AMP device in a same available time unit is one, an available candidate frequency-domain resource used by the AMP device in an (i+1)-th available time unit is determined based on at least one of:
an available candidate frequency-domain resource used by the AMP device in an i-th available time unit, a hop interval, a total number of available candidate frequency-domain resources for the AMP device in a deployment band corresponding to the AMP device, a smallest relative number of an available candidate frequency-domain resource for the AMP device in the deployment band corresponding to the AMP device, or a largest relative number of an available candidate frequency-domain resource for the AMP device in the deployment band corresponding to the AMP device.

11. The method of claim 3, wherein a first candidate frequency-domain resource initially selected by the AMP device is randomly selected, or the first candidate frequency-domain resource initially selected by the AMP device is configured by a network, or the first candidate frequency-domain resource initially selected by the AMP device is determined based on an identifier of the AMP device and/or an identifier of a peer device.

12. The method of claim 1, wherein:
the N candidate frequency-domain resources are part or all of candidate frequency-domain resources in a deployment band corresponding to the AMP device; and/or
in a case where the AMP device transmits the reference signal over the N candidate frequency-domain resources, the AMP device transmits the reference signal over all or part of resources in each candidate frequency-domain resource among the N candidate frequency-domain resources; and/or
the N candidate frequency-domain resources do not overlap, or part of the N candidate frequency-domain resources overlap.

13. The method of claim 1, wherein:
the reference signal transmitted by the AMP device contains a frame header or a packet header, or the AMP device transmits information carrying the frame header or the packet header before transmitting the reference signal;
the frame header or the packet header carries at least information of a time length in which a candidate frequency-domain resource is occupied;
the frame header or the packet header further carries at least one of:
information for identifying the AMP device;
information for identifying the receiver;
a synchronization/pilot sequence for obtaining synchronization information by the receiver; or
configuration information of the reference signal transmitted by the AMP device.

14. The method of claim 1, wherein:
transmitting, by the AMP device, the reference signal on the N candidate frequency-domain resources comprises:
transmitting, by the AMP device, the reference signal on the N candidate frequency-domain resources in a manner of active transmission or backscattering.

15. The method of claim 1, wherein each candidate frequency-domain resource is one of: a channel, a system bandwidth, a carrier bandwidth, a BWP, an aggregation/grouping/bundling of a plurality of BWPs, an aggregation/grouping/bundling of a plurality of subcarriers, and an aggregation/grouping/bundling of a plurality of PRBs.

16. The method of claim 1, wherein:
a number W of transmissions of the reference signal by the AMP device, a duration T, for a single transmission of the reference signal by the AMP device, and time T during which the AMP device is scheduled by a network for communication have the following association relationship: W*T₁≤T;
W is a positive integer, and both T and T, are positive numbers.

17. The method of claim 1, wherein:
a number of transmissions of the reference signal by the AMP device is predefined by a protocol, or the number of transmissions of the reference signal by the AMP device is configured by a network; and/or
a duration for a single transmission of the reference signal by the AMP device is predefined by a protocol, or the duration for a single transmission of the reference signal by the AMP device is configured by a network; and/or
a time interval between each two adjacent frequency-hopping transmissions of the reference signal by the AMP device is predefined by a protocol, or the time interval between each two adjacent frequency-hopping transmissions of the reference signal by the AMP device is configured by a network; and/or
a maximum duration for transmission of the reference signal by the AMP device is predefined by a protocol, or the maximum duration for transmission of the reference signal by the AMP device is configured by a network.

18. The method of claim 1, wherein:
different AMP devices use a same manner to determine candidate frequency-domain resources for transmitting reference signals for ranging and/or positioning based on a dual-frequency phase difference, or different AMP devices use different manners to determine candidate frequency-domain resources for transmitting reference signals for ranging and/or positioning based on a dual-frequency phase difference; and/or
different AMP devices transmit reference signals for ranging and/or positioning based on a dual-frequency phase difference in a manner of frequency-division multiplexing (FDM).

19. An ambient power (AMP) device, comprising:
a transceiver;
a processor coupled to the transceiver; and
a memory storing a computer program which, when executed by the AMP device, causes the AMP device to:
transmit a reference signal on N candidate frequency-domain resources;
wherein the reference signal transmitted on the N candidate frequency-domain resources is used to determine a position of the AMP device or a position of a receiver of the reference signal, and/or the reference signal transmitted on the N candidate frequency-domain resources is used to determine a distance between the AMP device and the receiver of the reference signal, wherein N is a positive integer and N≥2.

20. A communication device, comprising:
a transceiver;
a processor coupled to the transceiver; and
a memory storing a computer program which, when executed by the processor, causes the communication device to:
receive a reference signal transmitted by an ambient power (AMP) device on N candidate frequency-domain resources;
wherein the reference signal transmitted on the N candidate frequency-domain resources is used to determine a position of the AMP device or a position of the communication device, and/or the reference signal transmitted on the N candidate frequency-domain resources is used to determine a distance between the AMP device and the communication device, wherein N is a positive integer and N≥2.
